(19) United States
(12) Patent Application Publication
(10) Pub. No.: US 2024/0419203 A1
(43) Pub. Date: Dec. 19, 2024

(54) ROTATING LOAD DEVICE USING MAGNETO-RHEOLOGICAL FLUID AND CONTROL METHOD THEREFOR

(71) Applicant: CK MATERIALS LAB CO., LTD., Ansan-si Gyeonggi-do (KR)

(72) Inventors: Hyeong Jun KIM, Ansan-si Gyeonggi-do (KR); Jeen Gi KIM, Ansan-si Gyeonggi-do (KR); In Sik JEE, Ansan-si Gyeonggi-do (KR)

(73) Assignee: CK MATERIALS LAB CO., LTD., Ansan-si Gyeonggi-do (KR)

(21) Appl. No.: 18/820,497

(22) Filed: Aug. 30, 2024

Related U.S. Application Data
(63) Continuation of application No. PCT/KR2022/010876, filed on Jul. 25, 2022.

(30) Foreign Application Priority Data
Mar. 11, 2022 (KR) 10-2022-0030753

(51) Int. Cl. G05G 5/03; G05G 1/015; G05G 1/08; G05G 5/04; H01F 1/44

(52) U.S. Cl. CPC G05G 5/03; G05G 1/015; G05G 1/08; G05G 5/04; H01F 1/447; G05G 2505/00

(57) ABSTRACT

Provided is a magnetorheological rotating load apparatus and a control method therefor, the magnetorheological rotating load apparatus including a housing, a yoke fixed in the housing, a shaft mounted to rotate in the housing, at least one rotating ring connected to the shaft to rotate in conjunction with the rotation of the shaft, a coil disposed in the housing, and a magnetorheological fluid filled in at least a portion of the housing, wherein at least a portion of the shaft positioned inside the housing is made of a non-magnetic material.

### CROSS-REFERENCE TO RELATED APPLICATIONS

This application is a continuation of PCT/KR2022/010876 filed on Jul. 25, 2022, which claims priority to Korean Patent Application No. 10-2022-0030753 filed on Mar. 11, 2022, the entire contents of which are herein incorporated by reference.

### TECHNICAL FIELD

The present invention relates to a magnetorheological rotating load apparatus and a control method therefor, and more particularly, to magnetorheological rotating load apparatus including a magnetorheological fluid and being capable of changing rotational torque by applying a magnetic field to the magnetorheological fluid, and a control method therefor.

### BACKGROUND ART

Jog dials are a type of rotatable circular dials which are rotated clockwise or counterclockwise by a user to select a certain function. The dial may be placed at a specific position when the user releases the force applied to the jog dial, thereby enabling precise positioning.

The jog dials are being increasingly applied to computer mice, home appliances, etc., and also employed in vehicles as a main input device of a driver information system (DIS) such as a telematics system.

Existing mechanical jog dials are operated by gear engagement. As such, rotational haptic feedback of the existing mechanical jog dials is a single type of haptic feedback based on gear engagement and various types of haptic feedback based on rotations or usage modes may not be provided. In addition, the mechanical jog dials have only a rotational torque set based on gear engagement, and may not freely change the rotational torque. Although a driving means such as a motor may be further included to control the rotational torque or a vibration motor for providing the haptic function is added, because components and devices therefor are additionally required, a production cost and an apparatus size may be increased.

### SUMMARY OF THE INVENTION

### Technical Problem

The present invention provides a magnetorheological rotating load apparatus capable of providing a user with a variety of types of luxurious haptic feedback by generating various haptic feedback patterns based on various input signal when rotating, unlike an existing mechanical structure for generating a single monotonous haptic feedback pattern, and a control method therefor.

The present invention also provides a magnetorheological rotating load apparatus having an embedded haptic function to change rotational torque and being capable of reducing a production cost and an apparatus size, and a control method therefor.

The present invention also provides a magnetorheological rotating load apparatus capable of enabling various applications for different purposes by using shear characteristics or viscosity of a magnetorheological fluid, and a control method therefor.

However, the above description is an example, and the scope of the present invention is not limited thereto.

### Technical Solution

According to an aspect of the present invention, there is provided a magnetorheological rotating load apparatus including a housing, a yoke fixed in the housing, a shaft mounted to rotate in the housing, at least one rotating ring connected to the shaft to rotate in conjunction with the rotation of the shaft, a coil disposed in the housing, and a magnetorheological fluid filled in at least a portion of the housing.

According to another aspect of the present invention, there is provided a magnetorheological rotating load apparatus including a housing, a yoke fixed in the housing, a shaft mounted to rotate in the housing, at least one rotating ring connected to the shaft to rotate in conjunction with the rotation of the shaft, a coil disposed in the housing, and a magnetorheological fluid filled in at least a portion of the housing, wherein another end of the shaft opposite to an end of the shaft is spaced apart from an inner lower surface of the housing.

An end of the shaft may be positioned outside the housing and another end of the shaft opposite to the end of the shaft may be inserted into the rotating ring inside the housing.

At least a portion of the shaft positioned inside the housing may be made of a non-magnetic material.

A cover may be disposed on the yoke, and a bearing may be disposed on the cover.

The shaft may be inserted into a through hole of the bearing.

The rotating ring may include a plurality of rotating rings arranged in a vertical direction in contact with or at a certain interval from each other, and the shaft may be inserted into the rotating rings.

A certain gap provided at least between the yoke and the rotating ring and filled with the magnetorheological fluid may have a size 10 times to 200 times greater than an average diameter of magnetic particles in the magnetorheological fluid.

A certain gap provided at least between the yoke and the rotating ring and filled with the magnetorheological fluid may have a size of at least 0.1 mm to 5 mm.

The magnetorheological rotating load apparatus may further include a controller for controlling a magnetic field applied from the coil to the magnetorheological fluid.

The controller may transmit a pattern signal to the coil based on event pattern data corresponding to an effect of an event received from outside, or audio pattern data corresponding to an audio signal received from outside.

The controller may transmit a direct current (DC) offset signal to the coil based on offset data corresponding to an operating mode received from outside.

When it is determined that the shaft has reached a specific rotation position, the controller may transmit a rotation stop signal to the coil.

When it is determined that the shaft has reached a specific rotation position, the controller may transmit a position recognition signal to the coil.

When it is determined that the shaft rotates in a reverse rotation direction opposite to a forward rotation direction, the controller may transmit a rotation stop signal to the coil.

When it is determined that the shaft rotates in a reverse rotation direction opposite to a forward rotation direction, the controller may control the coil to apply no magnetic field to the magnetorheological fluid.

The controller may transmit a pre-input signal to the coil before the magnetorheological rotating load apparatus operates, and the pre-input signal may be a signal for moving particles settled in the magnetorheological fluid to form an incomplete or complete chain shape in at least one of vertical and horizontal directions in a certain gap, and then redispersing the particles.

The incomplete chain shape may be a spike shape.

When the controller applies an operating voltage V₁ to the coil and when it is determined that a height of chains formed by the particles of the magnetorheological fluid in the certain gap between the yoke and the rotating ring is lower than a height of the gap, the controller may apply a voltage V₂ higher than V₁.

When an operating temperature of the magnetorheological rotating load apparatus is increased compared to an initial operating temperature, the controller may maintain a torque strength of the initial operating temperature by controlling a strength or a pattern of the magnetic field.

At least one of a viscosity of the magnetorheological fluid, a content of magnetic particles in the magnetorheological fluid, numbers of yokes and rotating rings, areas of the yoke and the rotating ring, a size of a gap between the yoke and the rotating ring, and a strength of a current applied to the coil may be set to prevent rotation manipulation of a user in a specific situation by increasing a maximum value of rotational torque applied between the yoke and the rotating ring.

At least one of the housing, the yoke, and the rotating ring may include a portion made of a magnetic material.

### Advantageous Effects

According to the present invention, unlike an existing mechanical structure for generating a single monotonous haptic feedback pattern, various haptic feedback patterns may be generated based on various input signal when rotating a rotating load apparatus, and thus a user may be provided with a variety of types of luxurious haptic feedback.

Furthermore, according to the present invention, a haptic function may be embedded to change rotational torque, and a production cost and an apparatus size may be reduced.

In addition, according to the present invention, various applications may be enabled for different purposes by using shear characteristics or viscosity of a magnetorheological fluid.

However, the scope of the present invention is not limited to the above effects.

### DESCRIPTION OF THE DRAWINGS

FIG. 1 is a perspective view of a magnetorheological rotating load apparatus according to a first embodiment of the present invention.

FIG. 2 is an exploded perspective view of the magnetorheological rotating load apparatus according to the first embodiment of the present invention.

FIG. 3 is a cross-sectional view of the magnetorheological rotating load apparatus according to the first embodiment of the present invention.

FIG. 4 is an enlarged view of portion V of FIG. 3.

FIG. 5 is a schematic view showing the behavior of a magnetorheological fluid in a gap space, according to an embodiment of the present invention.

FIG. 6 is a graph showing a torque based on a magnetic field of a magnetorheological fluid, according to an embodiment of the present invention.

FIG. 7 is a perspective view of a magnetorheological rotating load apparatus according to a second embodiment of the present invention.

FIG. 8 is an exploded perspective view of the magnetorheological rotating load apparatus according to the second embodiment of the present invention.

FIG. 9 is a cross-sectional view of the magnetorheological rotating load apparatus according to the second embodiment of the present invention.

FIG. 10 is an enlarged view of portion VI of FIG. 9.

FIG. 11 is a schematic view showing magnetic force lines of a shaft made of a magnetic material, according to an embodiment of the present invention.

FIG. 12 is a perspective view of a magnetorheological rotating load apparatus according to a third embodiment of the present invention.

FIG. 13 is an exploded perspective view of the magnetorheological rotating load apparatus according to the third embodiment of the present invention.

FIG. 14 is a cross-sectional view of the magnetorheological rotating load apparatus according to the third embodiment of the present invention.

FIG. 15 is an enlarged view of portion VII of FIG. 14.

FIG. 16 is a cross-sectional view of a magnetorheological rotating load apparatus according to a fourth embodiment of the present invention.

FIG. 17 is a schematic view showing a yoke and rotating rings with fluid passage holes, according to an embodiment of the present invention.

FIG. 18 is a schematic view showing magnetic chains in fluid passage holes, according to an embodiment of the present invention.

FIG. 19 includes graphs showing a torque value before and after the formation of fluid passage holes, according to a test example.

FIG. 20 is a schematic view showing patterns on horizontal surfaces of a yoke and rotating rings, according to an embodiment of the present invention.

FIG. 21 is a schematic view showing patterns on horizontal surfaces of a yoke and rotating rings, and a rotation process, according to an embodiment of the present invention.

FIG. 22 includes graphs showing a torque value based on the viscosity of a magnetorheological fluid, according to a test example of the present invention.

FIG. 23 includes graphs showing a default torque value adjusted by a direct current (DC) offset voltage, according to an embodiment of the present invention.

FIG. 24 is a graph showing rotation stop of a magnetorheological rotating load apparatus according to an embodiment of the present invention.

FIG. 25 is a graph showing position recognition of a magnetorheological rotating load apparatus according to an embodiment of the present invention.

FIG. 26 is a graph showing reverse rotation stop of a magnetorheological rotating load apparatus according to an embodiment of the present invention.

FIG. 27 is a graph showing reverse rotational haptic feedback release of a magnetorheological rotating load apparatus according to an embodiment of the present invention.

FIG. 28 is a schematic view showing a process of redispersing settled particles of a magnetorheological fluid by applying a pre-input signal, according to an embodiment of the present invention.

FIG. 29 includes photographic images showing that particles of a magnetorheological fluid have a spike shape when a pre-input signal is applied, according to an embodiment of the present invention.

FIG. 30 is a graph showing a torque value based on a temperature of a magnetorheological fluid, according to a test example of the present invention.

FIG. 31 is a graph showing a torque value in a case when a magnetorheological rotating load apparatus is applied to an anti-lock brake system (ABS), according to an embodiment of the present invention.

FIG. 32 is a schematic view of a magnetorheological rotating load module according to an embodiment of the present invention.

FIGS. 33 to 38 show applications of a magnetorheological rotating load apparatus, according to embodiments of the present invention.

### DESCRIPTION OF REFERENCE NUMERALS

10: Magnetorheological Fluid
11: Magnetic Particles
12: Fluid
50: Controller
100 to 400: Magnetorheological Rotating Load Apparatus
110 to 410: Housing
120 to 420: Shaft
130 to 430: Coil
140 to 440: Yoke
150 to 450: Rotating Ring
G: Gap

### DETAILED DESCRIPTION OF THE INVENTION

The following detailed description of the invention will be made with reference to the accompanying drawings illustrating specific embodiments of the invention by way of example. These embodiments will be described in sufficient detail such that the invention may be carried out by one of ordinary skill in the art. It should be understood that various embodiments of the invention are different but do not need to be mutually exclusive. For example, a specific shape, structure, or characteristic described herein in relation to an embodiment may be implemented as another embodiment without departing from the scope of the invention. In addition, it should be understood that positions or arrangements of individual elements in each disclosed embodiment may be changed without departing from the scope of the invention. Therefore, the following detailed description should not be construed as being restrictive and, if appropriately described, the scope of the invention is defined only by the appended claims and equivalents thereof. In the drawings, like reference numerals denote like functions, and lengths, areas, thicknesses, and shapes may be exaggerated for convenience's sake.

Hereinafter, the present invention will be described in detail by explaining embodiments of the invention with reference to the attached drawings, such that one of ordinary skill in the art may easily carry out the invention.

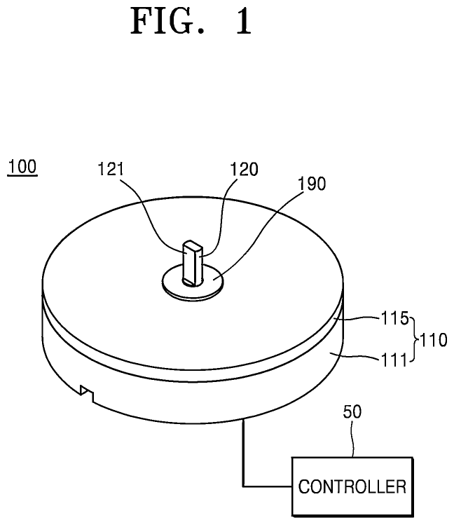

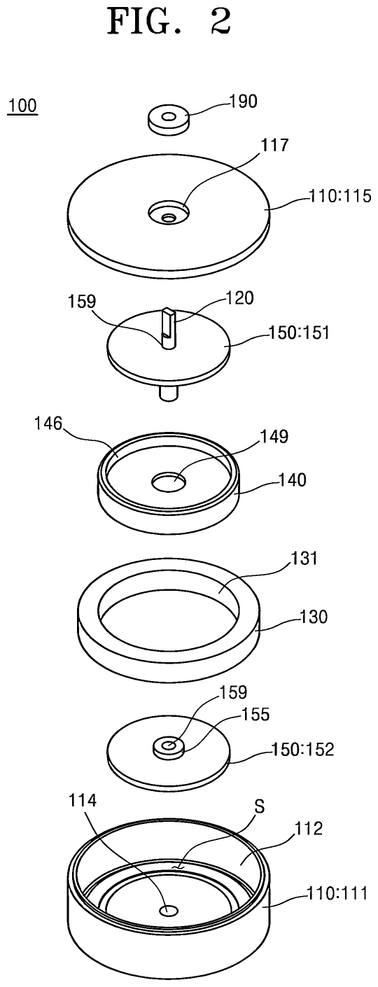

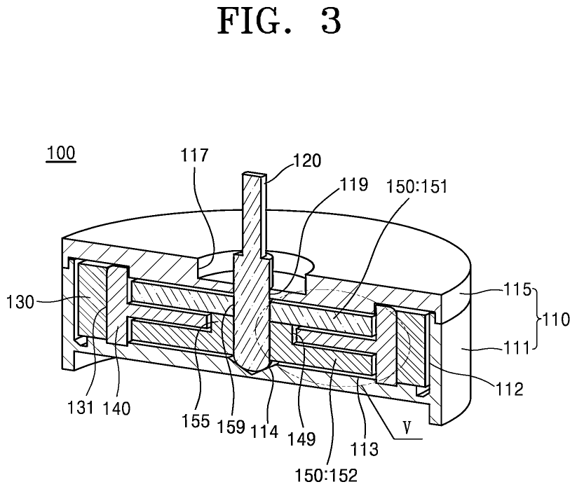

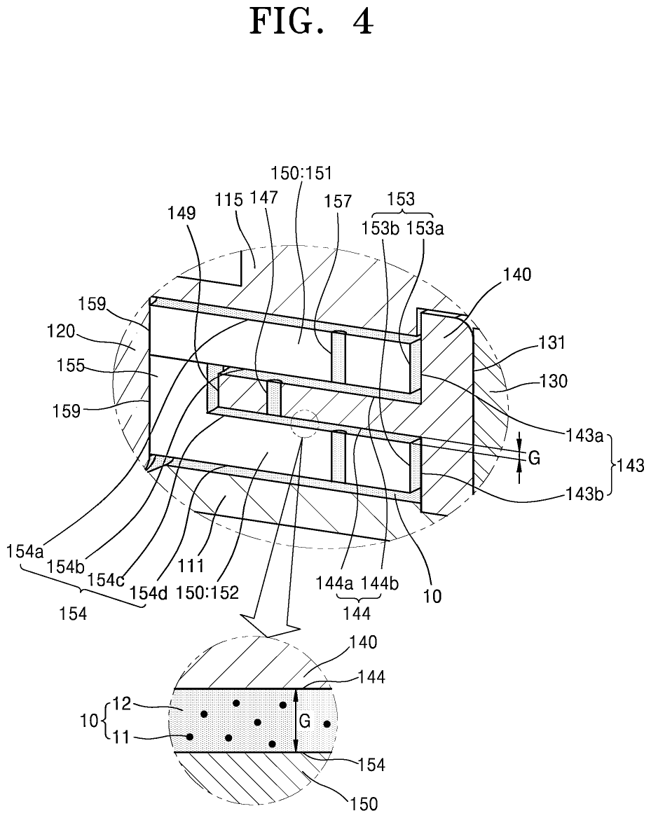

FIG. 1 is a perspective view of a magnetorheological rotating load apparatus 100 according to a first embodiment of the present invention. FIG. 2 is an exploded perspective view of the magnetorheological rotating load apparatus 100 according to the first embodiment of the present invention. FIG. 3 is a cross-sectional view of the magnetorheological rotating load apparatus 100 according to the first embodiment of the present invention. FIG. 4 is an enlarged view of portion V of FIG. 3.

Referring to FIGS. 1 to 4, the magnetorheological rotating load apparatus 100 of the first embodiment may include a housing 110, a shaft 120, a coil 130, a yoke 140, rotating rings 150, and a magnetorheological fluid 10, and further include a bearing 190.

The housing 110 provides a space S in which other components are disposed. Components of the magnetorheological rotating load apparatus 100 may be disposed in the housing 110, and the magnetorheological fluid 10 may be filled in a remaining empty space inside the housing 110. The housing 110 may have a substantially cylindrical shape to provide the space S in which the shaft 120 and the rotating rings 150 rotate, or have any other shape as long as the space S in which the shaft 120 and the rotating rings 150 rotate is providable.

For example, the housing 110:111 and 115 may include a first housing 111 for providing the space S in which the coil 130, the yoke 140, the rotating rings 150, and the magnetorheological fluid 10 are disposed, and a second housing 115 for sealing the internal space S of the first housing 111 by covering the top of the first housing 111.

After the components of the magnetorheological rotating load apparatus 100 and the magnetorheological fluid 10 may be disposed in the space S of the first housing 111, the open top of the first housing 111 may be covered by the second housing 115 to seal the space S. According to the present invention, the magnetorheological fluid 10 may be sealed and the assembly of the magnetorheological rotating load apparatus 100 may be completed merely by using the simple structure of the first and second housings 110:111 and 115.

The shaft 120 may be mounted to rotate at the center of the housing 110. The shaft 120 may extend in a vertical direction, and the rotating rings 150:151 and 152 may be put on portions of the shaft 120 to rotate with the shaft 120. Alternatively, the shaft 120 and the rotating rings 150 may be formed integrally with each other.

An edge 121 may be provided at an upper end of the shaft 120, and a user grip means (not shown) such as a dial may be put on the edge 121 at the upper end of the shaft 120 to easily transmit rotational force to the shaft 120.

A lower end of the shaft 120 may be seated in a shaft receiving indentation 114 provided in a lower surface of the first housing 111, and thus the shaft 120 may be supported not to axially deviate from the shaft receiving indentation 114 while rotating.

Meanwhile, an upper portion of the shaft 120 positioned inside the housing 110 may be inserted into and supported by the bearing 190. As such, because two portions of the shaft 120 are inserted into and supported by the bearing 190 and the rotating ring 152, the shaft 120 may be axially stably supported.

The coil 130 may be disposed inside the housing 110. To uniformly apply a magnetic field to the inside of the housing 110, the coil 130 may also have a ring shape with an opening to correspond to a vertical inner wall 112 of the housing 110, but is not limited thereto. The coil 130 is a solenoid coil and a magnetic field is formed when a current is applied. Due to the formed magnetic field, particles 11 of the magnetorheological fluid 10 may be arranged in a direction of magnetic force lines or in a vertical direction to form a chain structure. The chain structure may be formed between a fixed portion and a rotating portion of the magnetorheological rotating load apparatus 100 to provide torque to the rotating portion. Rotational torque control will be described in detail below.

The yoke 140 may be fixedly mounted in the housing 110. The yoke 140 may be fixedly mounted in such a manner that an outer surface thereof faces an inner surface 131 of the opening of the coil 130.

The yoke 140 may have a shape including at least first surfaces 143 and second surfaces 144 [see FIG. 4] facing the rotating rings 150:151 and 152 to be described below. In other words, an inner surface of the yoke 140 may include at least the first and second surfaces 143 and 144. Specifically, the yoke 140 may have a shape including the first surfaces 143: 143a and 143b facing outer circumferential surfaces 153: 153a and 153b [see FIG. 4] of the rotating rings 150:151 and 152, and the second surfaces 144: 144a and 144b facing rotating surfaces 154: 154a, 154b, 154c, and 154d of the rotating rings 150:151 and 152 and being perpendicular to the first surfaces 143. A through hole 149 through which the shaft 120 penetrates may be provided at the center of the yoke 140.

In another point of view, the yoke 140 may include a circular disc with the through hole 149, and a vertical wall 146 provided in a cylindrical shape and perpendicularly connected to an outer circumference of the circular disc, and thus a cross-section thereof (see FIG. 3) may have a substantially ‘H’ shape, excluding the through hole 149. To increase an area of surfaces facing each other, the rotating rings 150 may be seated in a space inside the vertical wall 146 of the yoke 140.

The rotating rings 150 may have a substantially circular disc shape and be connected to the shaft 120. The rotating rings 150:151 and 152 may have a through hole 159 corresponding to an outer diameter of the shaft 120, so as to be put on the shaft 120. With respect to the fixed yoke 140, the rotating rings 150 may relatively rotate in conjunction with the rotation of the shaft 120.

A plurality of rotating rings 150:151 and 152 may be disposed in the housing 110 and connected to the shaft 120 at an interval from each other. Particularly, any one rotating ring 152 may include a gap maintainer 155 at the center thereof to have a level difference from the rotating surface 154 of the rotating ring 152 [or the surface of the circular disc]. The gap maintainer 155 may also have the through hole 159. The through hole 149 of the yoke 140 may be provided to correspond to an outer diameter of the gap maintainer 155. Because the gap maintainer 155 is formed integrally with a rotating ring 150 to have a level difference, the interval between the rotating rings 150 may be maintained merely by sequentially putting the rotating rings 150 on the shaft 120 without putting an additional spacer on the shaft 120.

Although FIG. 3 shows an example in which the yoke 140 is disposed between two rotating rings 150:151 and 152, when the number of rotating rings is three or more, the number of yokes 140 may be increased or the shape of the yoke 140 may be changed to correspond to the number of rotating rings. In this case, the yoke 140 and the rotating rings 150 may be alternately stacked on one another in a vertical direction. The assembly may be completed through a process of fixedly disposing the coil 130 in the internal space S of the first housing 111, alternately stacking a rotating ring 150 and the yoke 140 on one another, inserting the shaft 120, stacking another rotating ring 150 [and an additional yoke 140] thereon, filling the magnetorheological fluid 10, and then sealing the internal space S with the second housing 115.

According to the present invention, rotational torque may be increased when the number or size of yokes 140 and rotating rings 150 is increased. Furthermore, the magnetorheological rotating load apparatus 100 may be configured through a simple process of alternately stacking the yoke 140 and the rotating rings 150 on one another in the housing 110:111 and 115 and coupling and assembling the first and second housings 111 and 115 to each other. Due to the simple process, the magnetorheological rotating load apparatus 100 may flexibly respond to changes in size to provide a torque value suitable for the purpose of use.

A certain gap G may be formed between the yoke 140 and the rotating rings 150, and the magnetorheological fluid 10 may be filled in the gap G. Specifically, the gap G may be formed between the first surfaces 143 of the yoke 140 and the outer circumferential surfaces 153 of the rotating rings 150, and between the second surfaces 144 of the yoke 140 and the rotating surfaces 154 of the rotating rings 150.

The gap G may also be formed between the housing 110 and the yoke 140, and between the housing 110 and the rotating rings 150. The rotational torque of the rotating rings 150 may be changed when properties, e.g., viscosity and rigidity, of the magnetorheological fluid 10 filled in the gap G are changed.

The magnitude of a torque T generated between the rotating rings 150 and the yoke 140 during rotational motion of the rotating rings 150 is obtained based on a shear stress and a contact area as follows.

$$T = {T}_{c} + {T}_{η} + {T}_{f}$$

Herein, T_{c} denotes a controllable torque generated at an electric or magnetic field load, T_{η} denotes a viscous torque due to the viscosity of the magnetorheological fluid 10 when no electric or magnetic field is applied, and T_{f} denotes a frictional torque generated by a mechanical element. T_{c} does not occur at no load.

Therefore, the present invention is characterized in that the total torque T of the magnetorheological rotating load apparatus 100 is freely changed by controlling a magnetic field applied from the coil 130 to the magnetorheological fluid 10, that is, by controlling T_{c}.

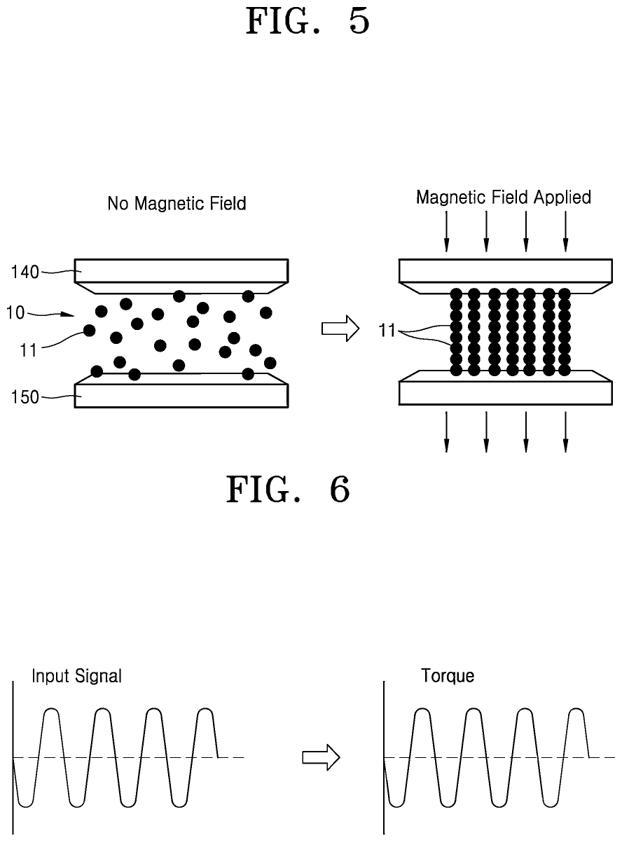

FIG. 5 is a schematic view showing the behavior of the magnetorheological fluid 10 in the gap space G, according to an embodiment of the present invention.

The magnetorheological rotating load apparatus 100 may further include a controller 50 for controlling a strength, frequency, waveform, or the like of a magnetic field generated by the coil 130. When a user rotates the shaft 120 of the magnetorheological rotating load apparatus 100, the controller 50 may change a torque of the rotating rings 150 by changing the magnetic field applied from the coil 130.

Referring to FIGS. 4 and 5, the magnetorheological fluid 10 may be filled in the gap G between the yoke 140 and the rotating rings 150 [or the gap G between the housing 110, the yoke 140, and the rotating rings 150]. The magnetorheological fluid 10 includes magnetic particles 11, and a fluid medium 12, e.g., oil or water, in which the magnetic particles 11 are dispersed.

In FIG. 5, when no magnetic field is applied (No Magnetic Field), the magnetic particles 11 are dispersed in the fluid medium 12. That is, because T_{c}=0 at no load, torque has a fixed value of T=T_{η}+Tt. On the other hand, when a magnetic field is applied (Magnetic Field Applied), the magnetic particles 11 may form magnetic chains in a direction of magnetic force lines. The chains may be substantially formed from a surface of the rotating ring 150 to reach a surface of the yoke 140. As such, because the value of T_{c} occurs, the torque may be increased to T=T_{c}+T_{η}+T_{f} and the total torque may be changed depending on the change in the value of T_{c}. As such, a torque required to rotate the shaft 120 may be changed depending on the strength of the magnetic field, the binding force of the magnetic chains, the frictional shear force of the yoke 140 and the rotating rings 150, or the like. To better form the magnetic chains, at least the housing 110 may include a magnetic portion, and the shaft 120, the yoke 140, and the rotating rings 150 may also include a magnetic portion. When an element includes a magnetic portion, it means that the entirety of the element is made of a magnetic material or only a portion of the element is made of a magnetic material. The magnetic material may include iron, nickel, cobalt, ferrite (Fe₃O₄), alloys thereof, or nitrated, oxidized, carbonized, or siliconized metal.

The gap G may have a size 10 times to 200 times, and more specifically, about 20 times greater than an average diameter of the magnetic particles 11 in the magnetorheological fluid 10. When the gap G is excessively small, the torque value at no load may be increased or interference may be caused when the components rotate, and difficulties may occur in assembly. When the gap G is excessively large, the apparatus size may not be easily reduced, and the magnetic chains may not be sufficiently formed at a small magnetic field. For example, the diameter of the magnetic particles 11 may range from about 2 μm to about 10 μm, and the average diameter may be about 5 μm. In this case, the gap G may be at least 0.1 mm or more, and more specifically, about 0.1 mm to about 5 mm. The magnetic particles 11 may form magnetic chains in a direction of magnetic force lines within the above-mentioned numerical range to cause a change in the value of T_{c} sufficient to provide a change in haptic feedback to the user's hand.

The more magnetic particles 11 in the magnetorheological fluid 10, the stronger the magnetic chains are formed to increase the maximum torque that may be generated by the rotating load apparatus. The magnetic particles 11 in the magnetorheological fluid 10 may be 60 wt % to 95 wt %. When the magnetic particles 11 are less than 60 wt %, the value of the maximum torque may be reduced and thus sufficient haptic feedback and rigidity may not be provided to the user. When the magnetic particles 11 are more than 95 wt %, the torque value at no load may be increased due to the excessive magnetic particles 11.

FIG. 6 is a graph showing a torque based on a magnetic field of a magnetorheological fluid, according to an embodiment of the present invention.

FIG. 6 shows how the torque is changed depending on the strength of the applied magnetic field. When the coil 130 applies an alternating current (AC) magnetic field, a torque of the shaft 120 corresponding thereto may be generated. Depending on the pattern of the magnetic field, the pattern of magnetic chains formed between the yoke 140 and the rotating rings 150 may be changed and the rotational torque of the shaft 120 connected to the rotating rings 150 may also be changed. As such, various patterns of haptic feedback may be provided to a user who rotates the shaft 120 of the magnetorheological rotating load apparatus 100.

Meanwhile, the controller 50 may generate a signal for providing various patterns of haptic feedback to the user, based on data received from an external device or the like. The controller 50 may generate a signal for controlling the rotational torque of the shaft 120, based on an event or audio generated by a display of the external device. The controller 50 may transmit a pattern signal to the coil 130, based on event pattern data corresponding to the effect of the event, or audio pattern data corresponding to the audio signal.

For example, when the magnetorheological rotating load apparatus 100 of the present invention is applied to a steering wheel of a racing game, changes in haptic feedback may be applied to the shaft 120 to correspond to the road condition while an event of moving a vehicle is being performed on the display. Alternatively, the rotational torque value of the shaft 120 may be applied differently depending on whether a driving mode of the racing game is a comfort mode or a sport mode.

As another example, haptic feedback may be implemented by the magnetorheological rotating load apparatus 100 when background music is played or a sound effect is generated in a game. When the magnetorheological rotating load apparatus 100 is applied to a mouse wheel, a torque value sufficient to stop the rotation of the shaft 120 connected to the mouse wheel may be applied when a warning sound effect is generated.

In addition, the controller 50 may control the operating frequency, strength, waveform, or the like of the coil 130 to implement haptic feedback with various patterns as well as haptic feedback based on a constant torque value.

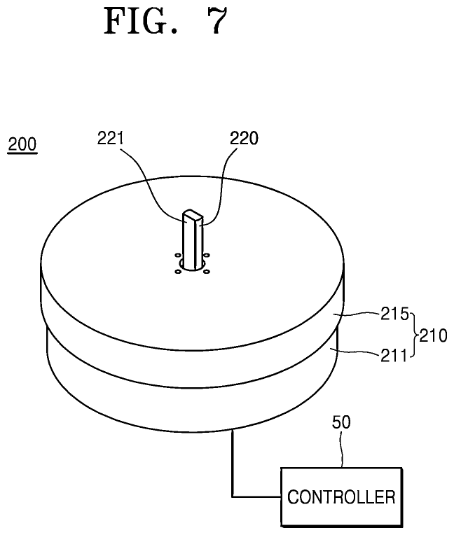

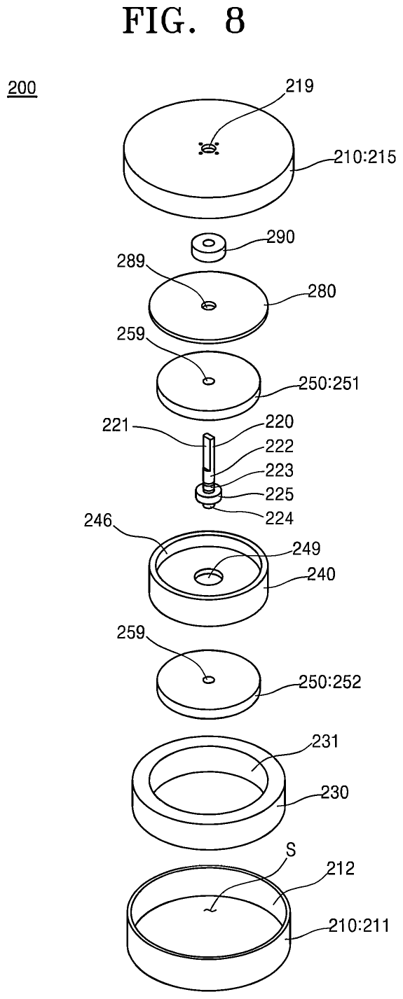

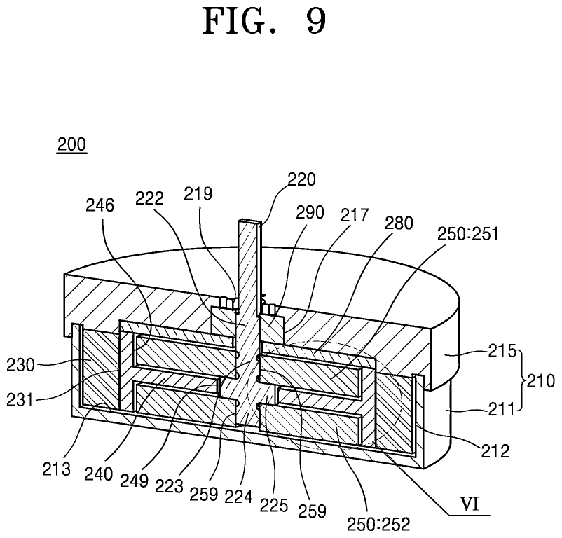

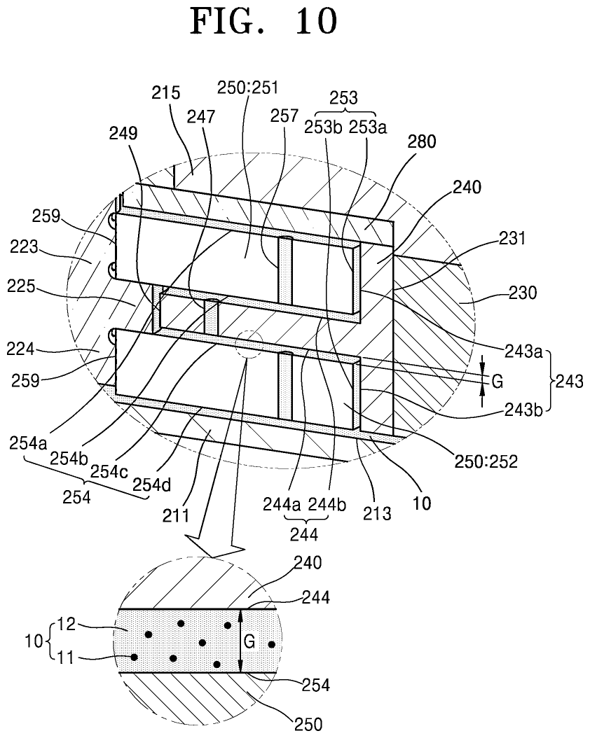

FIG. 7 is a perspective view of a magnetorheological rotating load apparatus 200 according to a second embodiment of the present invention. FIG. 8 is an exploded perspective view of the magnetorheological rotating load apparatus 200 according to the second embodiment of the present invention. FIG. 9 is a cross-sectional view of the magnetorheological rotating load apparatus 200 according to the second embodiment of the present invention. FIG. 10 is an enlarged view of portion VI of FIG. 9. Only elements different from those according to the first embodiment of FIGS. 1 to 4 will be described below and the same elements will not be repeatedly described. The elements denoted by reference numerals 1XX and 2XX in the first and second embodiments correspond to each other. Unless stated otherwise, the descriptions of the elements provided above in relation to FIGS. 1 to 4 are equally applied to FIGS. 7 to 10.

Referring to FIGS. 7 to 10, the magnetorheological rotating load apparatus 200 of the second embodiment may include a housing 210, a shaft 220, a coil 230, a yoke 240, rotating rings 250, and the magnetorheological fluid 10, and further include a cover 280 and a bearing 290.

The housing 210, the coil 230, and the yoke 240 are substantially the same as the housing 110, the coil 130, and the yoke 140 described above.

The shaft 220 is mostly the same as the above-described shaft 120, but a lower portion 224 of the shaft 220 may be inserted into a through hole 259 of a rotating ring 252 which is positioned at the bottom of the rotating rings 250, and thus the shaft 220 may be supported by the rotating ring 252 not to axially deviate from its position while rotating. A lower surface of the lower portion 224 of the shaft 220 may be spaced apart from an inner lower surface 213 of a first housing 211. That is, the lower portion 224 of the shaft 220 may be inserted only down to a middle portion of the through hole 259 of the rotating ring 252 without penetrating through the through hole 259. Therefore, because the lower portion 224 of the shaft 220 floats from the inner lower surface 213 of the first housing 211, mechanical abrasion of the lower portion 224 of the shaft 220 by the inner lower surface 213 of the first housing 211 may be prevented.

A plurality of rotating rings 250:251 and 252 may be disposed in the housing 210 and connected to the shaft 220 at an interval from each other. A gap maintainer 225 of the shaft 220 may be provided to have a certain thickness and an outer diameter greater than that of the shaft 220 so as to provide the interval between the rotating rings 250:251 and 252. A through hole 249 of the yoke 240 may be provided to correspond to the outer diameter of the gap maintainer 225. Because the gap maintainer 225 is formed integrally with the shaft 220 to have a level difference, the interval between the rotating rings 250 may be maintained merely by sequentially putting the rotating rings 250 on the shaft 220 without putting an additional spacer on the shaft 220.

The magnetorheological rotating load apparatus 200 of the second embodiment is characterized in that the shaft receiving indentation 114 of the first embodiment is removed and the lower portion 224 of the shaft 220 is inserted into the through hole 259 of the rotating ring 252 which is positioned at the bottom. Because the lower portion 224 of the shaft 220 is inserted only down to a middle portion of the through hole 259 of the rotating ring 252 without penetrating through the through hole 259, and thus floats in the air, mechanical abrasion thereof by the first housing 211 [or the shaft receiving indentation 114 of the first housing 111] may be prevented. Furthermore, because the lower portion 224 of the shaft 220 is axially fixed by the rotating ring 252 and an upper portion 222 of the shaft 220 is axially fixed by the bearing 290, the shaft 220 may be axially fixed to provide pure haptic torque without distortion. In addition, because the shaft receiving indentation 114 does not need to be formed in the lower surface as in the first housing 111, a production cost of components may be reduced. Besides, because friction between the shaft 220, the first housing 211, and the rotating rings 250 is minimized, mechanical rotational torque in a case when no magnetic field is applied may be significantly reduced.

Meanwhile, the cover 280 may be further disposed on the yoke 240. The cover 280 may be disposed on the upper edge of the yoke 240 to seal an internal space of the yoke 240. Because the magnetorheological fluid 10 is filled in the internal space of the yoke 240, the cover 280 may be substantially used to seal the internal space S of a second housing 215 except for the coil 230.

The bearing 290 into which the portion 222 of the shaft 220 is inserted may be disposed on the cover 280. The second housing 215 may be disposed on the coil 230, the cover 280, and the bearing 290 to seal the internal space S of the housing 210:211 and 215. A recess 217 may be formed in a lower surface of the second housing 215 to provide a space where the bearing 290 is to be disposed. The outer circumference of the bearing 290 may be supported by the recess 217, and the portion 222 of the shaft 220 may be inserted into a through hole of the bearing 290 to fix and support the bearing 290 on the cover 280. In addition, another bearing (not shown) may be put on the shaft 220 in the internal space of the housing 210.

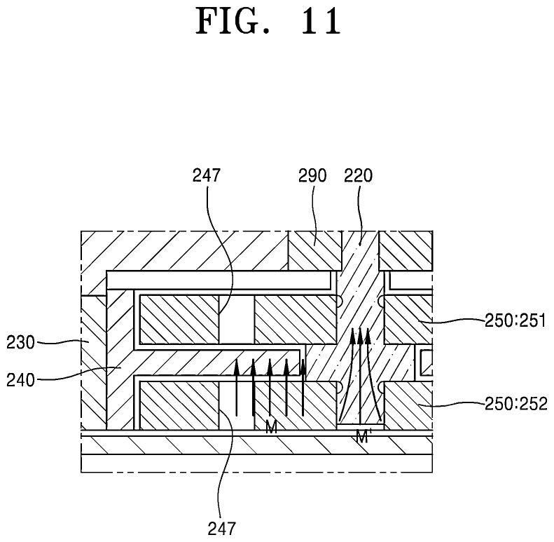

FIG. 11 is a schematic view showing magnetic force lines of a shaft made of a magnetic material, according to an embodiment of the present invention. The magnetorheological rotating load apparatus 200 of the second embodiment will be described as an example.

Referring to FIG. 11, the magnetic field applied from the coil 230 exhibits different behavior of magnetic force lines M or M′ depending on the material of the shaft 120. The magnetic field applied from the coil 230 to the yoke 240 and the rotating rings 250 may generate the magnetic force lines M in an upward direction perpendicular to horizontal surfaces of the yoke 240 and the rotating rings 250. Meanwhile, when the shaft 220 includes a magnetic material, the magnetic field applied from the coil 230 to the yoke 240 and the rotating rings 250 may partially leak toward the shaft 220 to generate the magnetic force lines M′. Due to the magnetic force lines M′ leaking toward the shaft 220, the concentration effect of the magnetic force lines M in the gap G may be reduced.

Therefore, the present invention is characterized in that the shaft 220 includes a non-magnetic material. When the shaft 220 includes a non-magnetic material, it means that the entirety of the shaft 220 is made of a non-magnetic material or only a portion of the shaft 220 is made of a non-magnetic material. Particularly, when only a portion of the shaft 220 is made of a non-magnetic material, at least a portion [e.g., the portion 222, 223, 224, or 225] of the shaft 220 positioned inside the housing 210 needs to be made of a non-magnetic material. According to an embodiment, the shaft 220 may use a plastic material. When the shaft 220 made of a plastic material is used, it is known that the torque value is increased from 70 mN·m to 110 mN·m compared to the shaft 220 using a magnetic material. Meanwhile, at least a portion of the housing 210 may be made of a magnetic material to increase the concentration effect of the magnetic force lines M. The portion of the housing 210 made of a magnetic material may be a portion adjacent to the yoke 240 and the rotating rings 250.

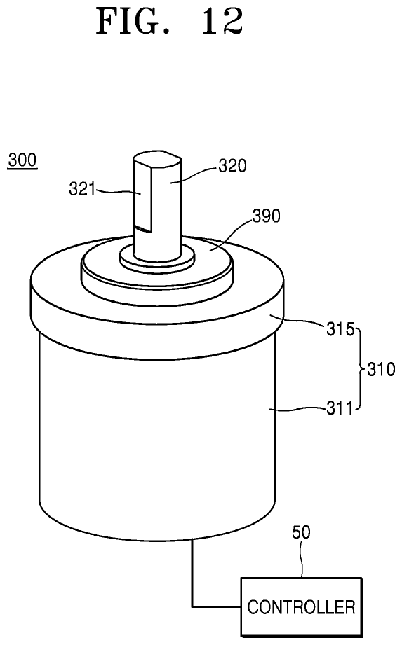

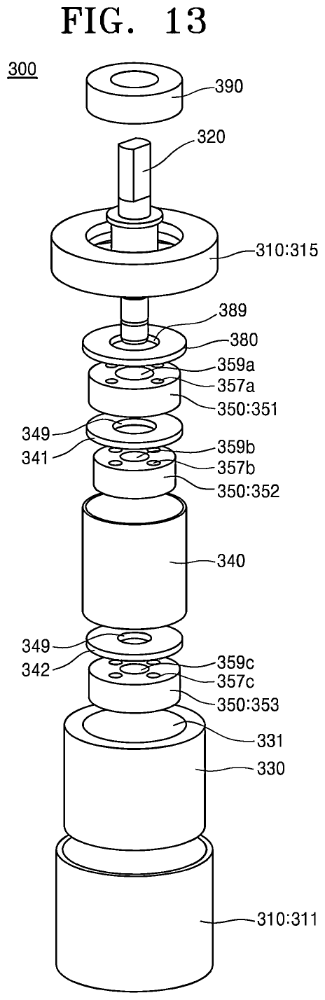

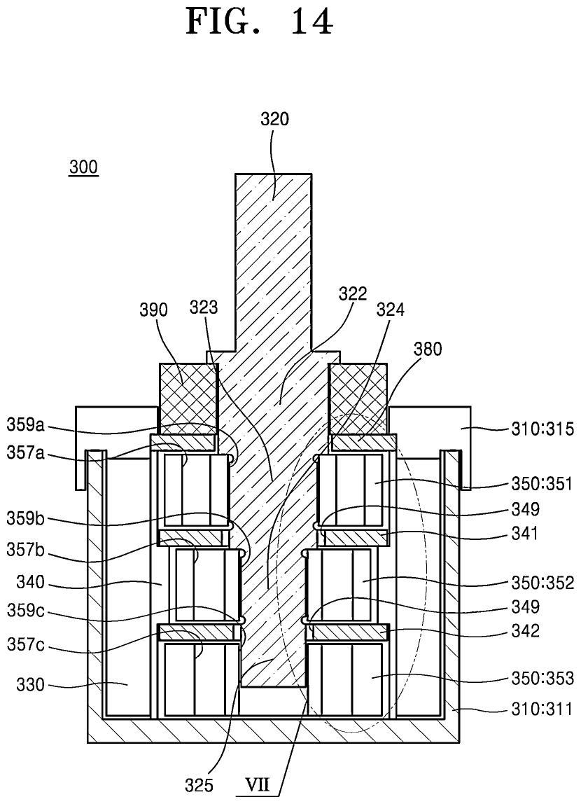

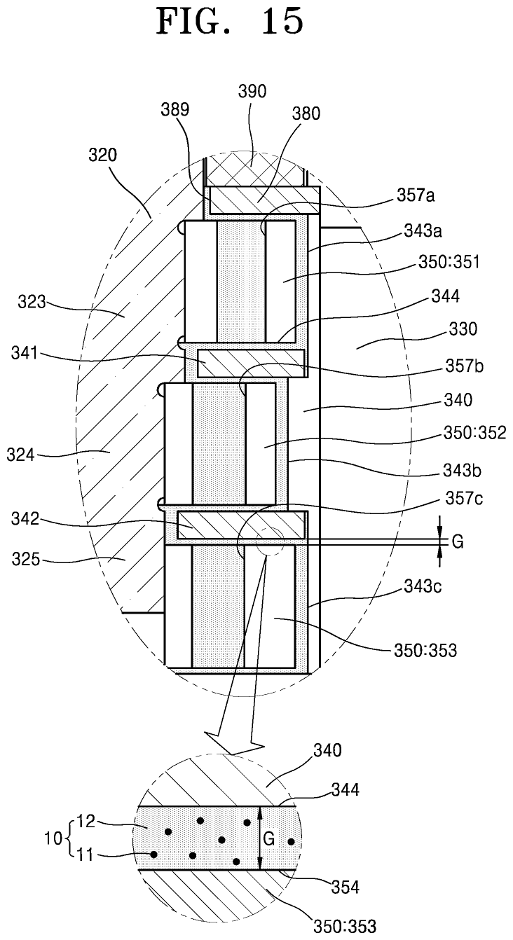

FIG. 12 is a perspective view of a magnetorheological rotating load apparatus 300 according to a third embodiment of the present invention. FIG. 13 is an exploded perspective view of the magnetorheological rotating load apparatus 300 according to the third embodiment of the present invention. FIG. 14 is a cross-sectional view of the magnetorheological rotating load apparatus 300 according to the third embodiment of the present invention. FIG. 15 is an enlarged view of portion VII of FIG. 14. Only elements different from those according to the first embodiment of FIGS. 1 to 4 will be described below and the same elements will not be repeatedly described. The elements denoted by reference numerals 1XX and 3XX in the first and third embodiments correspond to each other.

Referring to FIGS. 12 to 15, the magnetorheological rotating load apparatus 300 may include a housing 310, a shaft 320, a coil 330, a yoke 340, and rotating rings 350, and further include a cover 380 and a bearing 390. The housing 310 and the coil 330 may be substantially the same as those according to the first embodiment of FIGS. 1 to 4 except for slight differences in shape.

An edge 321 may be provided at an upper end of the shaft 320, and a user grip means (not shown) such as a dial may be put on the edge 321 at the upper end of the shaft 320 to easily transmit rotational force to the shaft 320.

The shaft 320 positioned inside the housing 310 may have a diameter gradually decreasing in a downward direction. A diameter of a portion 324 inserted into a middle rotating ring 352 may be less than the diameter of a portion 323 inserted into an upper rotating ring 351, and a diameter of a portion 325 inserted into a lower rotating ring 353 may be less than the diameter of the portion 324 inserted into the middle rotating ring 352. As such, the assembly procedure may be performed through a simple process of stacking the yoke 340 and the rotating rings 350:351 to 353 on one another and then inserting the shaft 220 in a downward direction.

The lower portion 325 may be inserted into a through hole 359c of the rotating ring 353 which is positioned at the bottom of the rotating rings 350, and thus the shaft 320 may be supported by the rotating ring 353 not to axially deviate from its position while rotating. A lower surface of the lower portion 325 of the shaft 320 may be spaced apart from an inner lower surface of a first housing 311. That is, the lower portion 325 of the shaft 320 may be inserted only down to a middle portion of the through hole 359c of the rotating ring 353 without penetrating through the through hole 359c. Therefore, because the lower portion 325 of the shaft 320 floats from the inner lower surface of the first housing 311, mechanical abrasion of the lower portion 325 of the shaft 320 by the inner lower surface of the first housing 311 may be prevented.

The coil 330 may be disposed inside the housing 310. To uniformly apply a magnetic field to the inside of the housing 310, the coil 330 may also have a ring shape with an opening to correspond to a vertical inner wall of the housing 310, but is not limited thereto. Due to the magnetic field formed from the coil 330, the particles 11 of the magnetorheological fluid 10 may be arranged in a direction of magnetic force lines to form a chain structure, thereby controlling rotational torque.

The yoke 340 may be fixedly mounted in the housing 310. The yoke 340 may be fixedly mounted in such a manner that an outer surface thereof faces an inner surface 331 of the opening of the coil 330. Like the housing 310, the yoke 340 may also have a substantially cylindrical shape to provide a space in which the shaft 320 and the rotating rings 350 rotate. The yoke 340 may have an inner diameter greater than outer diameters of the rotating rings 350 and yoke rings 341 and 342.

One or more rotating rings 350 and one or more yoke rings 341 and 342 may be disposed in an internal space of the yoke 340. The yoke 340 may have a protrusion on an inner surface thereof, and the yoke rings 341 and 342 may be caught and supported by the protrusion. The yoke rings 341 and 342 may be disposed alternately with the rotating rings 350:351, 352, and 353, and a certain gap G may be formed between the yoke rings 341 and 342 and the rotating rings 350:351, 352, and 353 and filled with the magnetorheological fluid 10. Although a case in which two yoke rings 341 and 342 are disposed between three rotating rings 350:351, 352, and 353 is described as an example herein, the numbers of rotating rings 350 and yoke rings 341 and 342 may be changed.

The yoke 340 may have a shape including at least first surfaces 343: 343a, 343b, and 343c and second surfaces 344 [see FIG. 15] facing the rotating rings 350:351, 352, and 353. The second surfaces 344 may be provided by horizontal surfaces of the yoke rings 341 and 342. In other words, the inner surface of the yoke 340 may include at least the first and second surfaces 343 and 344.

The yoke rings 341 and 342 may be disposed between the rotating rings 350. The yoke rings 341 and 342 may have a substantially circular disc shape such that the horizontal surfaces 344 thereof may face horizontal surfaces 354 of the rotating rings 350. A through hole 349 into which the shaft 320 is inserted may be provided at the centers of the yoke rings 341 and 342.

The rotating rings 350 and the yoke rings 341 and 342 may be alternately disposed along a vertical direction in the internal space of the yoke 340. The vertical direction corresponds to an axial direction of the shaft 320, and a horizontal direction corresponds to a planar direction of the rotating rings 350. As such, the surfaces of the yoke 340 and the yoke rings 341 and 342 may form the certain gap G from the surfaces of the rotating rings 350 [see FIG. 15].

Meanwhile, the cover 380 may be further disposed on the yoke 340. The cover 380 may be disposed on the upper edge of the yoke 340 to seal the internal space of the yoke 340. Because the magnetorheological fluid 10 is filled in the internal space of the yoke 340, the cover 380 may be substantially used to seal the internal space S of a second housing 315 except for the coil 330.

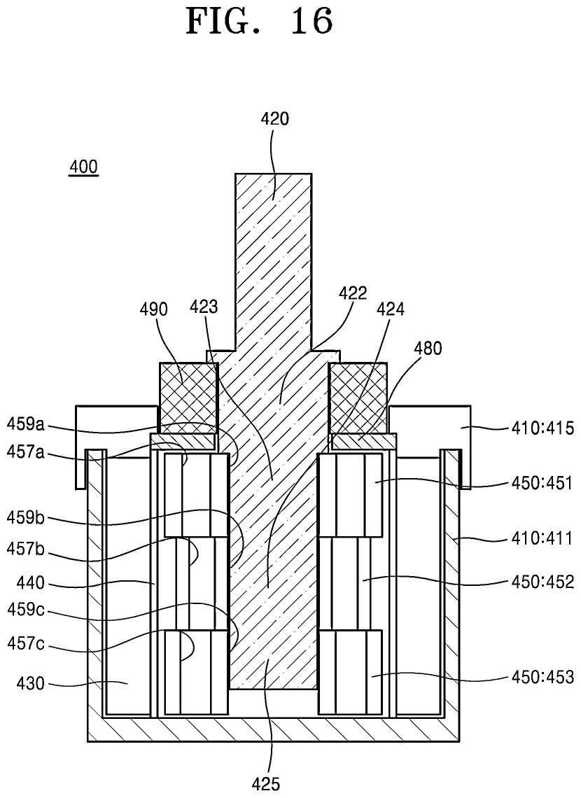

FIG. 16 is a cross-sectional view of a magnetorheological rotating load apparatus 400 according to a fourth embodiment of the present invention. Only elements different from those according to the third embodiment of FIGS. 12 to 15 will be described below and the same elements will not be repeatedly described. The elements denoted by reference numerals 3XX and 4XX in the third and fourth embodiments correspond to each other.

Referring to FIG. 16, the magnetorheological rotating load apparatus 400 may include a housing 410, a shaft 420, a coil 430, a yoke 440, and rotating rings 450, and further include a cover 480 and a bearing 490. However, the fourth embodiment is different from the third embodiment in that yoke rings [e.g., the yoke rings 341 and 342 of FIG. 14] are not present between rotating rings 451, 452, and 453. The rotating rings 450:451, 452, and 453 may be arranged in a vertical direction in contact with or at a certain interval from each other, and the shaft 420 may be inserted into through holes 457a, 457b, and 457c of the rotating rings 450.

An inner surface of the yoke 440 may have a certain gap G from outer surfaces of the rotating rings 450, and the magnetorheological fluid 10 may be filled in the gap G. Due to a magnetic field formed from the coil 430, the particles 11 of the magnetorheological fluid 10 may be arranged in a direction of magnetic force lines to form a chain structure, thereby controlling rotational torque.

In the magnetorheological rotating load apparatus 400 according to the fourth embodiment, because yoke rings are excluded, the rotational torque may be reduced compared to the third embodiment. On the other hand, the magnetorheological rotating load apparatus 400 may achieve a simple structure and a reduction in production cost and thus be applied in consideration of a required strength of rotational torque and a production cost. For example, the magnetorheological rotating load apparatus 400 may be applied to products which require weak rotational torque and enable a reduction in production cost, e.g., mouse wheels.

According to existing mechanical jog dials, the diversity of patterns based on various user modes may not be provided because only a single type of haptic feedback is providable, and abrasion may be caused by mechanical operation. In addition to the mechanical jog dials, vibration-motor-type jogs may also be used. However, because the vibration-motor-type jogs provide indirect haptic feedback using a vibration motor disposed thereunder rather than direct haptic feedback, the haptic feedback may not be effectively provided compared to the direct haptic feedback.

On the other hand, according to the present invention, a user may receive various types of haptic feedback because various torque patterns may be formed based on an input signal of a magnetic field applied from the coil 130, 230, 330, or 430, the problem of abrasion may be solved because shear force is changed depending on changes in the state of the magnetorheological fluid 10, and direct haptic feedback may be provided through the shaft 120, 220, 320, or 420.

Furthermore, according to the present invention, the characteristics of the magnetorheological fluid 10 may be controlled for the purposes of various applications based on the properties of the magnetorheological fluid 10. For example, a magnetorheological fluid with high viscosity may be used when heavy haptic feedback is required.

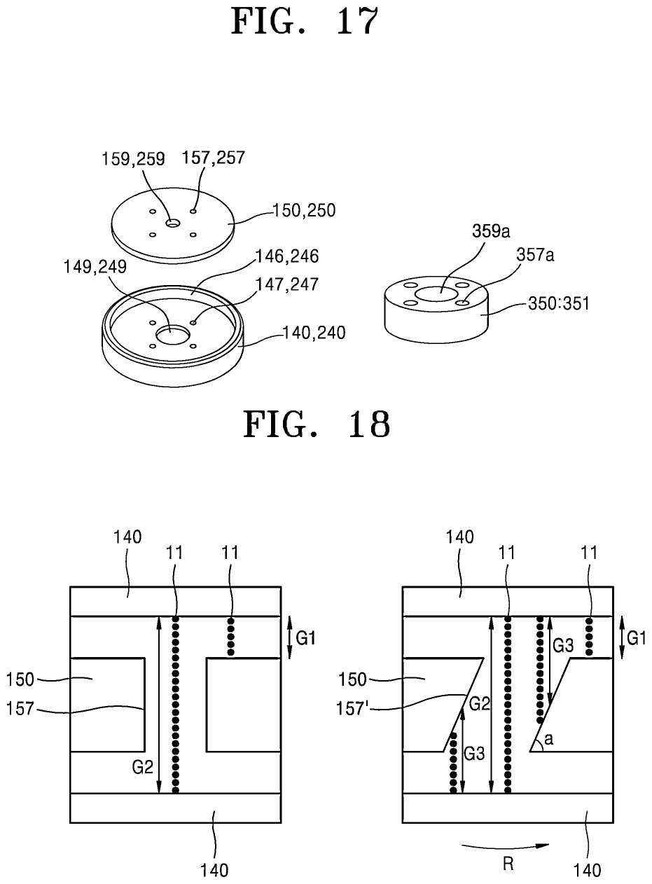

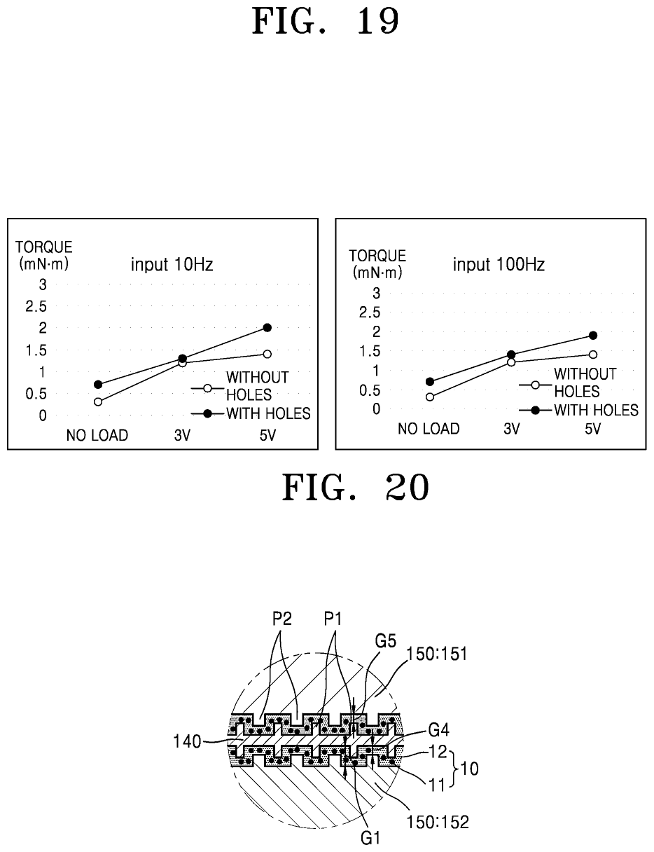

FIG. 17 is a schematic view showing the yoke 140 or 240 and the rotating rings 150, 250, or 350 with fluid passage holes 147 or 247, and 157, 257, or 357a, according to an embodiment of the present invention. FIG. 18 is a schematic view showing magnetic chains in the fluid passage holes 147 or 247, and 157, 257, or 357a, according to an embodiment of the present invention. FIG. 19 includes graphs showing a torque value before and after the formation of fluid passage holes, according to a test example.

Referring to FIG. 17, the yoke 140 or 240 may be provided with a plurality of fluid passage holes 147 or 247. The rotating rings 150, 250, or 350 may also be provided with a plurality of fluid passage holes 157, 257, or 357a. Like the rotating rings 150, 250, or 350, the yoke rings 341 and 342 may also be provided with a plurality of fluid passage holes. The fluid passage holes 147 or 247, and 157, 257, or 357a may be formed to vertically penetrate through horizontal surfaces such as the surfaces 144 or 244 of the yoke 140 or 240 and the rotating surfaces 154, 254, or 354 of the rotating rings 150, 250, or 350. The fluid passage holes are not limited thereto and may also be formed to horizontally penetrate through a vertical surface such as the vertical wall 146 or 246.

Referring to the left part of FIG. 18, the fluid passage holes 157 may increase a length of vertical chains formed by the magnetic particles 11 of the magnetorheological fluid 10 (G1→G2). That is, the length of the chains of the magnetic particles 11 may be increased from the thickness of the gap G or G1 to a gap G2 obtained by adding the thickness of the fluid passage holes 157 thereto. As such, when the same load is applied, a change in the value of T_{c} may be increased and total torque may also be increased.

According to an embodiment, when the yoke 140, 240, 340, or 440 and the rotating rings 150, 250, 350, or 450 have a diameter of about 10 mm, the fluid passage holes 147 or 247, and 157, 257, or 357a may have a diameter of about 0.3 mm. In addition, the fluid passage holes 147 or 247, and 157, 257, or 357a may allow the magnetorheological fluid 10 to be more uniformly spread in the assembly process of the magnetorheological rotating load apparatus 100, 200, 300, or 400.

Referring to the right part of FIG. 18, fluid passage holes 157′ may be inclined at an angle a instead of being formed vertically) (a=90°. Because the fluid passage holes 157′ are inclined, the chains of the magnetic particles 11 may be increased along increased surfaces of the fluid passage holes 157′. That is, in addition to the gap G or G1 and the gap G2 obtained by adding the thickness of the fluid passage holes 157′, the chains of the magnetic particles 11 may be further formed in a gap G3 from inclined surfaces of the fluid passage holes 157′ to the rotating surfaces 154 of the rotating rings 150 or the surfaces 144 of the yoke 140. Particularly, the fluid passage holes 157′ may be inclined along a rotation direction R of the rotating rings 150.

The angle a of inclination may be set in consideration of the diameter of the fluid passage holes 157′, the number of fluid passage holes 157′, the strength of rotational torque, or the like, and may be 30° to 80°. When the angle a is less than 30°, the fluid passage holes 157′ may penetrate through the horizontal surfaces at an excessively large size so as not to easily exhibit the effect of fluid passage holes. When the angle a is greater than 80°, a significant difference in effect from the vertical fluid passage holes 157 may not be exhibited.

In another point of view, the fluid passage holes 157 or 157′ may provide spaces where the chains of the magnetic particles 11 with various sizes, lengths, and directions are formed, e.g., the gaps G, G1, G2, and G3.

Referring to FIG. 19, when loads are applied at 10 Hz and 100 Hz, higher torques are exhibited when the fluid passage holes 147 or 247, and 157, 257, or 357a are provided. Even at no load for applying no magnetic field, higher torques are exhibited when the fluid passage holes 147 or 247, and 157, 257, or 357a are provided. It may be regarded that the above result is because the value of the viscous torque In or the frictional torque Tt is increased due to the flow of the magnetorheological fluid 10 into the fluid passage holes 147 or 247, and 157, 257, or 357a.

FIG. 20 is a schematic view showing patterns on horizontal surfaces of the yoke 140 and the rotating rings 150, according to an embodiment of the present invention. FIG. 20 is a side cross-sectional view of the yoke 140 and the rotating rings 150.

Referring to FIG. 20, bump patterns P1 may be formed on the surfaces 144 of the yoke 140, or bump patterns P2 may be formed on the rotating surfaces 154 of the rotating rings 150. The bump patterns P1 and P2 may increase a surface area between the yoke 140 and the rotating rings 150 to form more magnetic chains. As such, in the magnetorheological rotating load apparatus 100 of the same size, rotational torque may be increased. In addition to the bump patterns P1 and P2, surface roughness of the surfaces 144 of the yoke 140 and the rotating surfaces 154 of the rotating rings 150 may be increased to increase the surface area and form more magnetic chains. Alternatively, the gaps G1, G2, and G3 with various heights may be formed by increasing the surface roughness of the surfaces 144 of the yoke 140 and the rotating surfaces 154 of the rotating rings 150.

The bump patterns P1 and P2 may be formed on only the yoke 140 or the rotating rings 150, or both. The bump patterns P1 and P2 may be formed to face or alternate with each other.

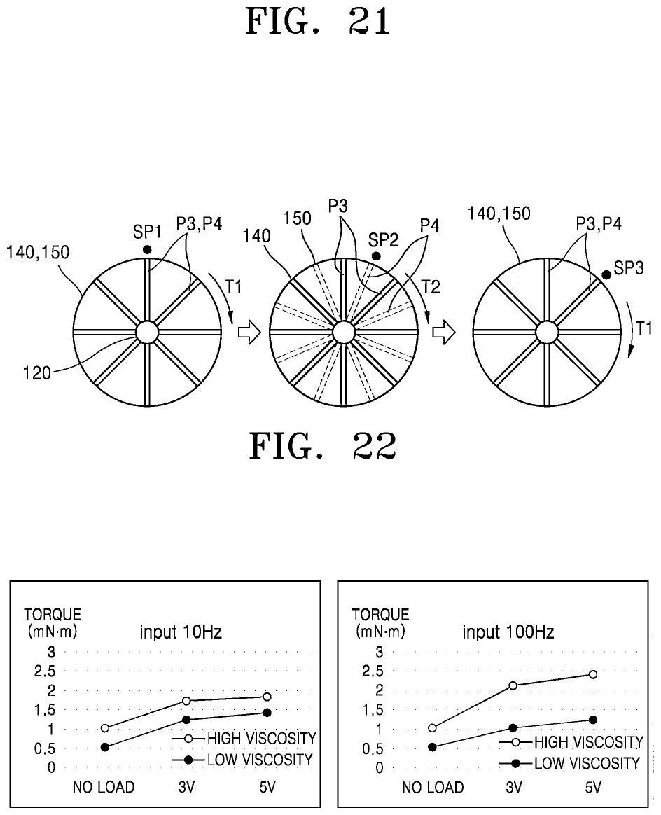

FIG. 21 is a schematic view showing patterns on horizontal surfaces of the yoke 140 and the rotating rings 150, and a rotation process, according to an embodiment of the present invention. FIG. 21 is a plan view of the yoke 140 and the rotating rings 150.

Referring to FIG. 21, bump patterns P3 and P4 may be formed in regions on the surfaces 144 and 154 of the yoke 140 and the rotating rings 150. The regions, interval, angle, or the like of the bump patterns P3 and P4 may be freely changed.

For example, a total of 8 pairs of bump patterns P3 and P4 may be radially formed at 45° to face each other on the yoke 140 and the rotating rings 150. As shown in the first part of the drawing, a user may rotate the shaft 120 from point SP1 in a clockwise direction. In this case, because the bump patterns P3 and P4 face each other and magnetic chains are formed in a short gap (corresponding to the distance between the bump patterns), a relatively strong torque T1 may be applied. Then, as shown in the second part of the drawing, when the user rotates the shaft 120 from point SP2, because magnetic chains are formed in a relatively long gap (corresponding to the distance between the surfaces of the yoke and the rotating rings) in regions where the bump patterns P3 and P4 do not face each other, a relatively weak torque T2 may be applied. Because the torque weakened from T1 to T2 is applied, the user may be provided with haptic feedback of loosened rotation. Thereafter, as shown in the third part of the drawing, when the rotation reaches point SP3, because the bump patterns P3 and P4 face each other again and magnetic chains are formed in a short gap (corresponding to the distance between the bump patterns), the relatively strong torque T1 may be applied. Because the torque strengthened from T2 to T1 is applied, the user may be provided with haptic feedback of tightened rotation. As described above, while rotating the shaft 120, the user may be provided with haptic feedback corresponding to a torque which is changed depending on the regions.

FIG. 22 includes graphs showing a torque value based on the viscosity of a magnetorheological fluid, according to a test example of the present invention. For example, a low viscosity is set to be about 0.15 Pa·s, a high viscosity is set to be about 0.4 Pa·s, and a density is set to be about 2.8 g/ml and about 3.8 g/ml. The high or low viscosity may be set based on the content of magnetic particles. A high content of magnetic particles may be set as the high viscosity, and a low content of magnetic particles may be set as the low viscosity.

Referring to FIG. 22, when loads are applied at 10 Hz and 100 Hz, higher torques are exhibited when the magnetorheological fluid 10 has a high viscosity. As such, a torque value, which may not be easily implemented even by increasing a load voltage to 10V or more at the low viscosity, may be implemented using the high-viscosity magnetorheological fluid 10. In another point of view, a high torque value may be implemented by increasing the content of magnetic particles.

For example, at 5V, a torque higher than 1.5 mN·m may not be easily implemented with the low viscosity but even a torque higher than 2 mN·m may be implemented with the high viscosity. Particularly, by maximizing a torque value implementable using a load of 12V in a vehicle, rotation of the rotating load apparatus may be prevented in specific situations (e.g., hazardous situations or while driving). By setting the viscosity of the magnetorheological fluid 10 so as to increase the maximum torque of the magnetorheological rotating load apparatus 100 as described above, a safety lock function for blocking rotation manipulation by the user may be implemented. As long as the rotation manipulation by the user may be blocked at the maximum torque value, in addition to the adjusting of the viscosity, the safety lock function may also be implemented through a structural change for, for example, increasing the numbers of rotating rings and yokes, increasing an area (an area of surfaces facing each other or a surface area), or reducing the gap G. Furthermore, the safety lock function may also be implemented by applying a higher current to the coil.

The safety lock function is a function by which the magnetorheological rotating load apparatus 100 blocks general rotation manipulation by a user to ensure the user's safety, and is characterized in that a higher torque value is required compared to general rotation manipulation. Because the user needs to recognize a torque value which is sufficiently distinguished from general rotation manipulation, the torque value generated to implement the safety lock function may be more than 1.5 times higher than an average torque value generated for general rotation manipulation. For example, safety may be ensured by preventing dangerous manipulation while driving a vehicle (e.g., changing gears with a jog dial while driving), or unexpected manipulation by children while a home appliance such as a washing machine is in operation may be prevented.

FIG. 23 includes graphs showing a default torque value adjusted by a direct current (DC) offset voltage, according to an embodiment of the present invention.

Referring to FIG. 23, the controller 50 may transmit a DC offset signal to the coil 130 based on offset data corresponding to an operating mode received from the outside.

For example, when the magnetorheological rotating load apparatus 100 is applied to a mouse wheel and when soft basic wheel operation is required, as shown in the left part of FIG. 23, the controller 50 may transmit a DC offset signal for controlling the DC offset voltage to be low or 0V, to the coil 130. On the other hand, when the wheel needs to rotate heavily for precise wheel operation, as shown in the right part of FIG. 23, the controller 50 may transmit a DC offset signal for controlling the DC offset voltage to be high, to the coil 130.

As another example, when the magnetorheological rotating load apparatus 100 is applied to a vehicle and when a jog dial (i.e., the rotating load apparatus) is set to a normal driving mode, as shown in the left part of FIG. 23, the controller 50 may transmit a DC offset signal for controlling the DC offset voltage to be low or 0V, to the coil 130 to provide haptic feedback of light vibration or low torque. On the other hand, when the jog dial is set to a sport driving mode, as shown in the right part of FIG. 23, the controller 50 may transmit a DC offset signal for controlling the DC offset voltage to be high, to the coil 130 to provide haptic feedback of strong vibration or strong torque.

Meanwhile, when the jog dial is rotated to change gears in the vehicle, the vibration or torque may be provided with a different strength by varying the DC offset voltage depending on whether the gear is in park (P), drive (D), neutral (N), or reverse (R). As such, the user may easily change driving modes or gears only based on haptic feedback while looking forward without checking the jog dial with the eyes.

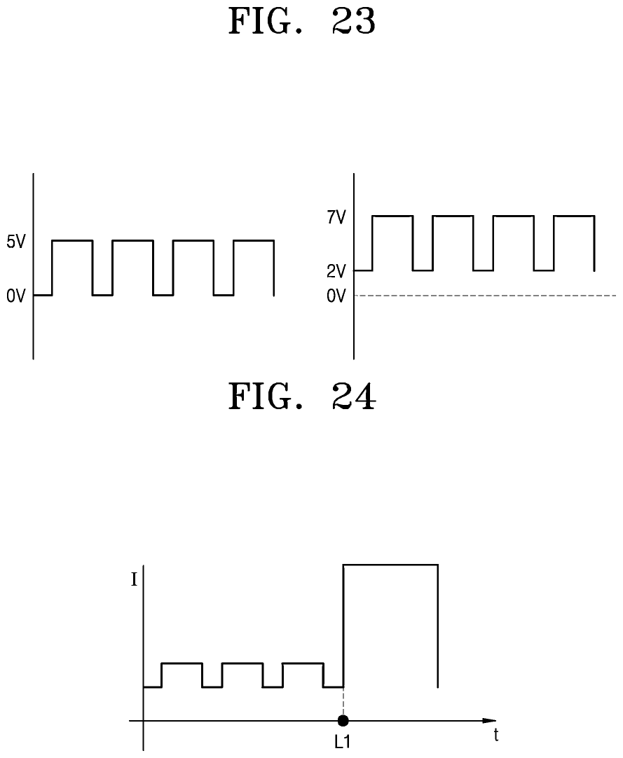

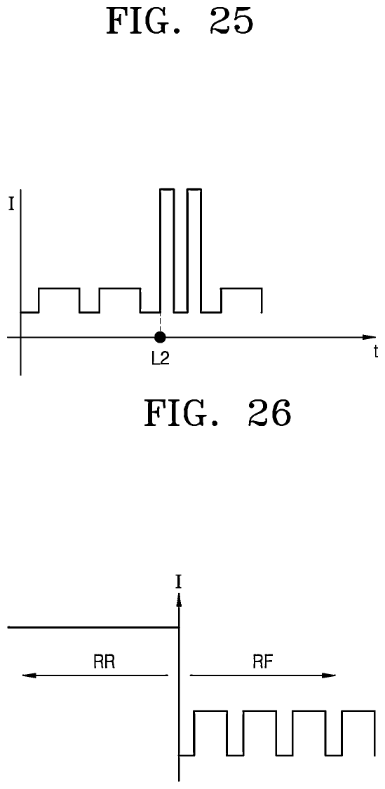

FIG. 24 is a graph showing rotation stop of a magnetorheological rotating load apparatus according to an embodiment of the present invention. FIG. 25 is a graph showing position recognition of a magnetorheological rotating load apparatus according to an embodiment of the present invention.

Referring to FIG. 24, when it is determined that the shaft 120 has reached a specific rotation position L1, the controller 50 may transmit a rotation stop signal to the coil 130. In order to be distinguished from a torque value experienced when a user generally rotates the shaft 120, the rotation stop signal may be a signal capable of implementing a significant torque value by the coil 130. The rotation stop signal may be a continuous or intermittent signal.

Referring to FIG. 25, when it is determined that the shaft 120 has reached a specific rotation position L2, the controller 50 may transmit a rotation stop signal to the coil 130. This rotation stop signal may be similar to the rotation stop signal of FIG. 24, but the user may experience rotation stop in a very short cycle. The rotation stop signal of FIG. 25 may be a continuous or intermittent signal which returns to a signal for implementing a general rotational torque value of the shaft 120. Therefore, the user may recognize a position because resistance is experienced only at a specific position while rotating the shaft 120.

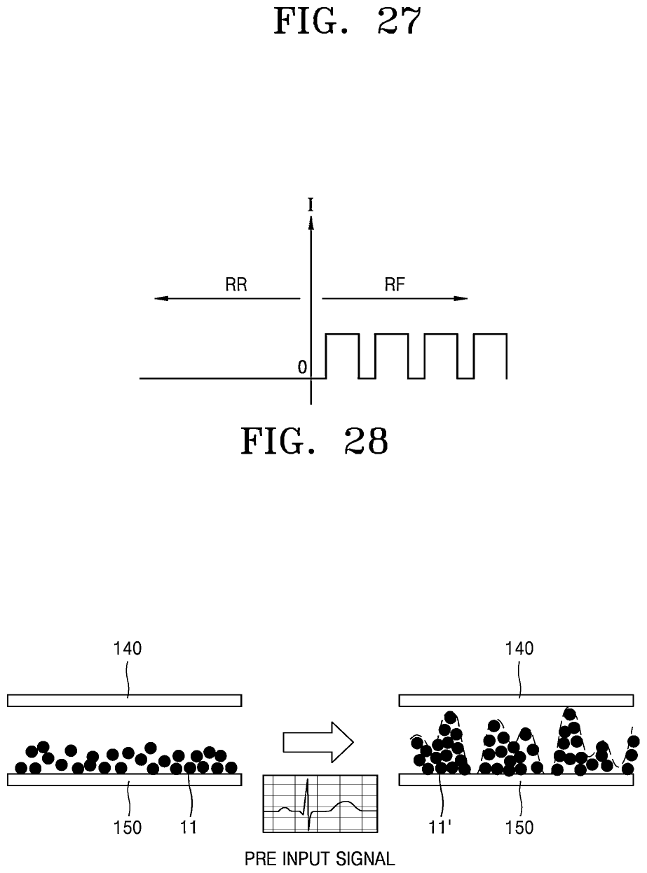

FIG. 26 is a graph showing reverse rotation stop of a magnetorheological rotating load apparatus according to an embodiment of the present invention. FIG. 27 is a graph showing reverse rotational haptic feedback release of a magnetorheological rotating load apparatus according to an embodiment of the present invention.

Referring to FIG. 26, when it is determined that the shaft 120 rotates in a reverse rotation direction RR opposite to a forward rotation direction RF, the controller 50 may transmit a rotation stop signal to the coil 130. In order to be distinguished from a torque value experienced when a user generally rotates the shaft 120, the rotation stop signal may be a signal capable of implementing a significant torque value by the coil 130. The rotation stop signal may correspond to a torque value generated when the safety lock function described above in relation to FIG. 22 is implemented. A torque value generated due to the rotation stop signal may be more than 1.5 times higher than an average torque value generated for general rotation manipulation. The rotation stop signal may be a continuous or intermittent signal. Therefore, the user may be provided with haptic feedback indicating that only rotation in the forward rotation direction RF is enabled and rotation in the reverse rotation direction RR is blocked.

Referring to FIG. 27, when it is determined that the shaft 120 rotates in the reverse rotation direction RR opposite to the forward rotation direction RF, the controller 50 may control the coil 230 to apply no magnetic field to the magnetorheological fluid 10. Because the magnetic field applied from the coil 230 is 0 when the shaft 120 rotates in the reverse rotation direction RR, the shaft 220 may rotate with no resistance without receiving a torque due to the formation of magnetic chains. Therefore, the user may be provided with haptic feedback only when the shaft 220 rotates in the forward rotation direction RF, and provided with the release of the haptic feedback when the shaft 220 rotates in the reverse rotation direction RR.

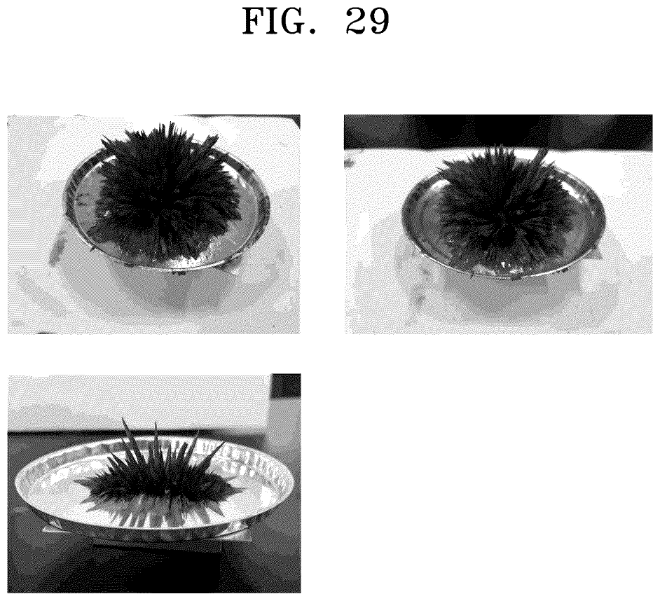

FIG. 28 is a schematic view showing a process of redispersing settled particles of a magnetorheological fluid by applying a pre-input signal, according to an embodiment of the present invention. FIG. 29 includes photographic images showing that particles of a magnetorheological fluid have a spike shape when a pre-input signal is applied, according to an embodiment of the present invention.

When the magnetorheological fluid 10 is used, the settling of the magnetic particles 11 in the fluid medium 12 may cause a problem. Because the magnetic particles sink down over time, when the magnetic particles are not evenly dispersed in the housing 110, magnetic chains may not be properly formed. Alternatively, when the magnetorheological rotating load apparatus 100 is repeatedly used, the magnetic particles 11 may be concentrated in a specific portion of the gap G between the yoke 140 and the rotating rings 150. For example, in the apparatus 100 of the first embodiment, more chains may be formed near outer portions of the yoke 140 and the rotating rings 150 because the outer portions are close to the solenoid coil 130, and less chains may be formed near inner portions of the yoke 140 and the rotating rings 150 due to a weak magnetic field because the inner portions are close to the shaft 120 and far from the solenoid coil 130. As described above, the magnetic particles 11 may be concentrated in a specific region of the gap G due to the settling of the magnetic particles 11, and particularly, the magnetic particles 11 may be settled and concentrated in a lower region of the housing 110. When the magnetorheological rotating load apparatus 100 is directly operated in this state, a torque of a magnitude different from a preset magnitude may occur.

Therefore, the present invention is characterized in that, when the magnetic particles 11 are settled down in the magnetorheological rotating load apparatus 100, to properly redisperse the magnetic particles 11, the controller 50 transmits a pre-input signal of a spike, pulse, or sine wave shape to the coil 130 before the magnetorheological rotating load apparatus 100 is operated. When the magnetorheological rotating load apparatus 100 is not operated for more than a set time, the controller 50 may transmit the pre-input signal to the coil 130 before operation.

The pre-input signal is different from the input signal for forming magnetic chains, which is described above in relation to FIG. 5. As a signal for moving the magnetic particles in the magnetorheological fluid 10 to form an incomplete or complete chain shape in at least one of vertical and horizontal directions in the gap G, the pre-input signal does not need to have a specific frequency, waveform, or the like and may be a signal for applying one or more strong magnetic fields. The pre-input signal does not need to be a signal for forming complete magnetic chains of the magnetic particles 11 connected from a lower surface of the gap G [e.g., an upper surface of the rotating ring 150] to an upper surface of the gap G [e.g., a lower surface of the yoke 140]. FIG. 29 shows examples of various spike shapes which are incomplete chain shapes of the magnetic particles.

When a magnetic field is applied from the coil 130 based on the pre-input signal, the particles 11 settled in the magnetorheological fluid 10 may form an incomplete chain shape, e.g., a spike shape, in the direction of the magnetic field, and at the same time or immediately after that, the application of the magnetic field may be released or only a weak magnetic field may be applied. As such, the shape of spikes or the like may be released and the magnetic particles 11 forming the incomplete chain shape such as the spike shape may be spread and redispersed in the gap G.

Meanwhile, when an operating voltage V₁ of the magnetorheological rotating load apparatus 100 is applied and when it is determined that the lowest height of the magnetic chains formed in the gap G between the yoke 140 and the rotating rings 150 is lower than the height of the gap G, the controller 50 may apply a pre-input signal voltage V₂ higher than V₁ to solve the above problem.

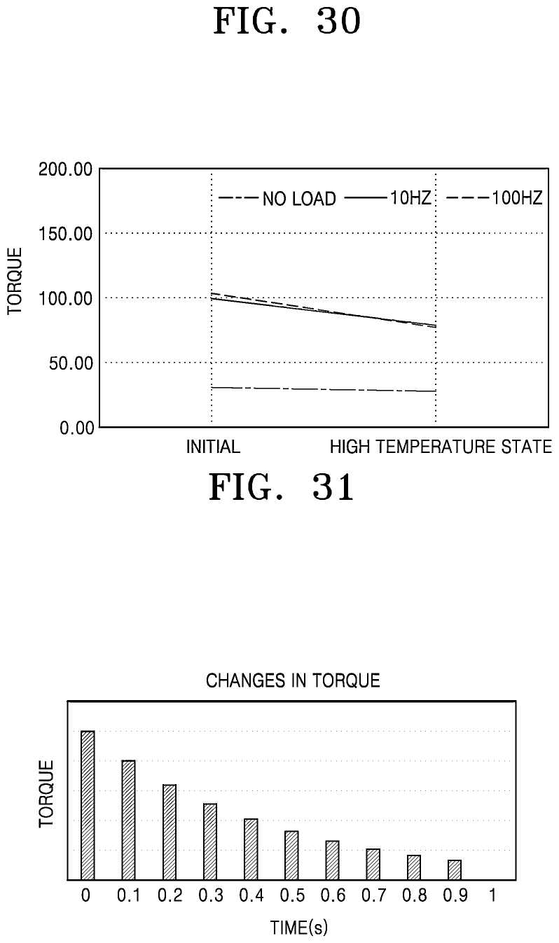

FIG. 30 is a graph showing a torque value based on a temperature of a magnetorheological fluid, according to a test example of the present invention.

Referring to FIG. 30, it is shown that, at 5V, the torque is gradually reduced from an initial state (or a default state) to a high temperature state (a state in which the rotating load apparatus is operating) due to changes in viscosity and shear stress characteristics of the magnetorheological fluid. Therefore, after the operating temperature of the magnetorheological rotating load apparatus is sensed, when it is determined that the temperature is increased compared to the initial operating temperature, in order to compensate for the reduction in torque due to the increase in temperature, the controller 50 may control the strength, pattern, or the like of the magnetic field to maintain the torque strength of the initial operating temperature in the high temperature state. As such, the uniformity of torque value may be ensured regardless of an external temperature environment, e.g., summer or winter.

FIG. 31 is a graph showing a torque value in a case when a magnetorheological rotating load apparatus is applied to an anti-lock brake system (ABS), according to an embodiment of the present invention.

As described above, the magnetorheological rotating load apparatus of the present invention may increase torque by stacking the yoke 140 and the rotating rings 150 on one another in multiple layers or increasing a surface area thereof, or by stacking the yoke rings 141 and 142 and the rotating rings 150 on one another in multiple layers or increasing a surface area thereof. As such, the magnetorheological rotating load apparatus may be applied to a target device which requires high torque. The target device may be a transportation means such as a vehicle, and the magnetorheological rotating load apparatus may be a braking system such as a brake.

Particularly, according to the present invention, unlike existing mechanical brake systems which employ a complicated structure and various components to instantaneously change a torque value, various torque values may be implemented merely by changing the strength or pattern of a magnetic field applied from a coil. As such, the magnetorheological rotating load apparatus of the present invention may be applied to an ABS system to implement changes in torque as shown in FIG. 31.

When the tires are locked momentarily during sudden braking of the vehicle, the vehicle may lose braking power and skid on the ground due to inertial force (vehicle speed). The maximum static friction occurs at the moment when the vehicle starts to skid, and kinetic friction, which is relatively low, may be applied when the vehicle skids thereafter. The ABS system may maximize the frictional force by repeatedly generating a short moment when maximum static friction is applied, and continuously creating a moment when static friction is changed to kinetic friction.

Existing ABS systems additionally requires an ABS modulator including a pump, accumulator, etc. for controlling hydraulic pressure and pressure release of the brake, and may not easily shorten a cycle of a static friction application pattern. On the other hand, the magnetorheological rotating load apparatus of the present invention may implement an ABS system by using a simple configuration for controlling the strength and cycle of applying a magnetic field.

According to an embodiment, to solve the problem that vehicle steering is disabled due to a wheel lock function when the vehicle is suddenly braked, a wheel slip ratio may be maintained at about 20%. The slip ratio (%) may be calculated as {V (vehicle speed)-V (wheel speed)}/V (wheel speed).

The brake system to which the present invention is applied may solve the durability problem caused by repeated hydraulic brake control, enable precise brake control, and prevent frequent failure of the ABS modulator.

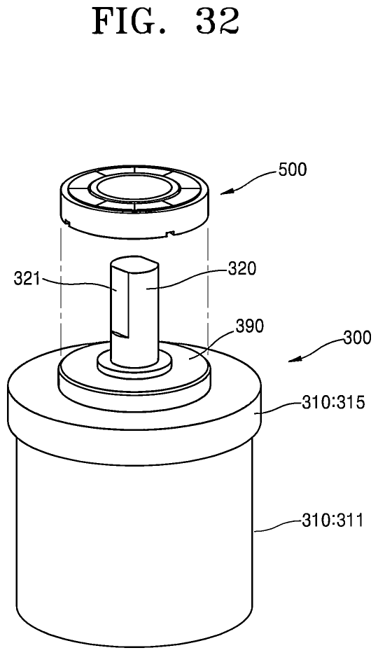

FIG. 32 is a schematic view of a magnetorheological rotating load module according to an embodiment of the present invention.

Various units may be coupled to the magnetorheological rotating load apparatus 100, 200, 300, or 400 to form a rotating load module. According to an embodiment, the magnetorheological rotating load module may have a form in which an encoder sensor 500 is coupled to the magnetorheological rotating load apparatus 300. Although the bearing 390 is generally coupled to the shaft 320 to reduce rotational friction, the encoder sensor 500 in which the bearing 390 is coupled to an encoder for sensing data about the speed, position, and direction of rotation may be coupled to the magnetorheological rotating load apparatus 300.

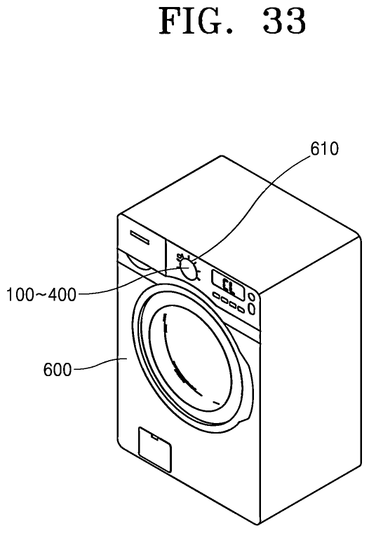

FIGS. 33 to 38 show applications of a magnetorheological rotating load apparatus, according to embodiments of the present invention.

The magnetorheological rotating load apparatus or rotating load module may be applied to any device equipped with a dial or wheel.

Referring to FIG. 33, the magnetorheological rotating load apparatus 100, 200, 300, or 400 may be applied to a user interface (UI) 610 of a washing machine 600, a microwave oven, or the like to place a dial [e.g., the shaft 120, 220, 320, or 420] at a position corresponding to various driving modes and provide various types of haptic feedback based on the driving modes. For example, in the washing machine, soft rotational haptic feedback may be provided when a normal washing mode is set, and rotational haptic feedback with a strong torque may be provided when a power washing mode is set.

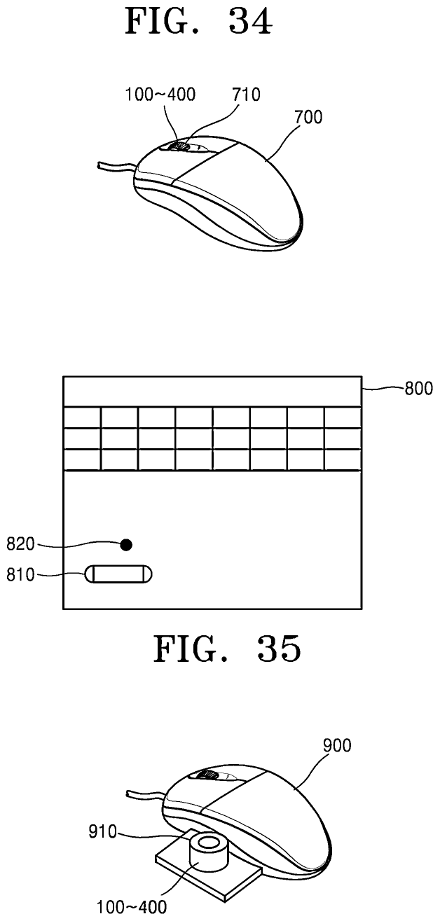

Referring to FIG. 34, the magnetorheological rotating load apparatus 100, 200, 300, or 400 may be applied to a wheel 710 of a mouse 700 to provide various types of haptic feedback by changing the rotational torque of the wheel 710 based on a usage environment. For example, when a hazardous situation occurs in a game, the torque for driving the wheel 710 may be increased. As shown in the lower part of FIG. 34, in a brick breaker game 800 for moving a reflector 810 left and right by rotating the mouse wheel 710 up and down, when the wheel is rotated upward until the reflector is moved to the left edge and there is no more space to move, the torque of the mouse wheel 710 rotated upward may be strengthened to indicate that the mouse wheel 710 is no more rotatable upward and is rotatable downward only. At a moment when a ball 820 is reflected on the reflector 810, the rigidity of the wheel 710 may be instantaneously changed to provide a user with haptic feedback indicating that the ball 820 is reflected.

Referring to FIG. 35, a mouse 900 may include a dial 910 in addition to buttons and a wheel. The magnetorheological rotating load apparatus 100, 200, 300, or 400 may be applied to the dial 910 to set various driving modes of the mouse 900. Alternatively, the dial 910 itself may be used as an input means in conjunction with the buttons and the wheel of the mouse 900, and haptic feedback based on changes in rotational torque may be provided during the input process.

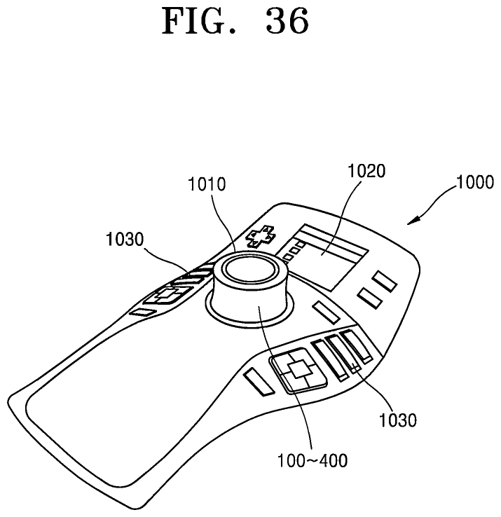

Referring to FIG. 36, a vehicle controller 1000 may include a dial-type shifter or driving mode selector 1010. The vehicle controller 1000 may further include a display 1020 to display driving state information of a vehicle, and further include buttons 1030 to set auxiliary driving options. The magnetorheological rotating load apparatus 100, 200, 300, or 400 may be applied to the dial-type shifter or driving mode selector 1010 to change various driving modes of the vehicle. For example, when the dial-type shifter 1010 changes gears between park (P), drive (D), neutral (N), and reverse (R), the torque may be changed to provide haptic feedback indicating the gear change. Particularly, when the dial-type shifter 1010 is to be abruptly rotated from drive (D) to park (P) or reverse (R), a safety lock function may be implemented by controlling the rotational torque value to be rapidly increased. As another example, the rotational torque value may be applied differently depending on whether the driving mode selected by the driving mode selector 1010 is a comfort mode or a sport mode.

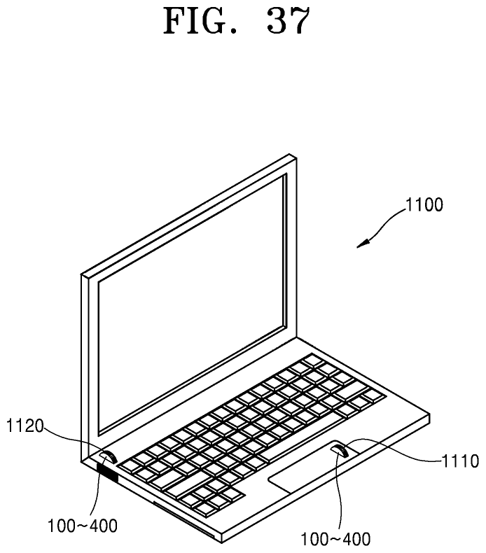

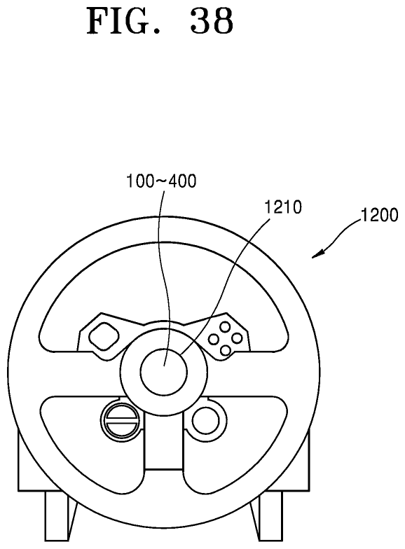

Referring to FIG. 37, a laptop 1100 or a computer may further include a functional part 1110 such as a wheel on a touchpad positioned below a keyboard. Alternatively, the laptop 1100 or the computer may further include a functional part 1120 such as a wheel on the keyboard. The magnetorheological rotating load apparatus 100, 200, 300, or 400 may be applied to the functional part 1110 or 1120 to provide various types of haptic feedback by changing the rotational torque of the wheel 710 based on a usage environment.

Referring to FIG. 38, the magnetorheological rotating load apparatus 100, 200, 300, or 400 may be applied to a shaft 1210 of a steering wheel 1200 for a racing game or a vehicle. For example, the steering wheel 1200 for the racing game may provide changes in haptic feedback by changing the rotational torque of the magnetorheological rotating load apparatus 100, 200, 300, or 400 to respond to the road condition while the vehicle is moving in a game screen. As another example, the rotational torque value of the steering wheel 1200 may be applied differently depending on whether a driving mode of the racing game is a comfort mode or a sport mode.

Meanwhile, in the afore-described embodiments of FIGS. 33 to 38, the mouse, keyboard, steering wheel, vehicle, or home appliance may further include a button for switching on or off or configuring settings for the haptic function. Alternatively, a settings window may be provided on a control screen (e.g., a PC screen or a smartphone screen) connected to the mouse, keyboard, steering wheel, vehicle, or home appliance, to switch on or off the haptic function or set the strength, pattern, or the like of haptic feedback.

As described above, according to the present invention, because various patterns may be made based on various input signals when rotating a rotating load apparatus, a user may be provided with a variety of types of luxurious haptic feedback. In addition, according to the present invention, rotational torque may be changed, a production cost and an apparatus size may be reduced, and various applications may be enabled for different purposes by using shear characteristics or viscosity of a magnetorheological fluid.

While the present invention has been particularly shown and described with reference to embodiments thereof, it will be understood by one of ordinary skill in the art that various modifications and changes in form and details may be made therein without departing from the scope of the present invention. Such modifications and changes are considered to be included in the scope of the present invention as defined by the following claims.

The invention claimed is:

1. A magnetorheological rotating load apparatus comprising:
a housing;
a yoke fixed in the housing;
a shaft mounted to rotate in the housing;
at least one rotating ring connected to the shaft to rotate in conjunction with the rotation of the shaft;
a coil disposed in the housing; and
a magnetorheological fluid filled in at least a portion of the housing.

2. A magnetorheological rotating load apparatus comprising:
a housing;
a yoke fixed in the housing;
a shaft mounted to rotate in the housing;
at least one rotating ring connected to the shaft to rotate in conjunction with the rotation of the shaft;
a coil disposed in the housing; and
a magnetorheological fluid filled in at least a portion of the housing,
wherein another end of the shaft opposite to an end of the shaft is spaced apart from an inner lower surface of the housing.

3. The magnetorheological rotating load apparatus of claim 1, wherein an end of the shaft is positioned outside the housing and another end of the shaft opposite to the end of the shaft is inserted into the rotating ring inside the housing.

4. The magnetorheological rotating load apparatus of claim 1, wherein at least a portion of the shaft positioned inside the housing is made of a non-magnetic material.

5. The magnetorheological rotating load apparatus of claim 1, wherein a cover is disposed on the yoke, and a bearing is disposed on the cover.

6. The magnetorheological rotating load apparatus of claim 5, wherein the shaft is inserted into a through hole of the bearing.

7. The magnetorheological rotating load apparatus of claim 1, wherein the rotating ring comprises a plurality of rotating rings arranged in a vertical direction in contact with or at a certain interval from each other, and
wherein the shaft is inserted into the rotating rings.

8. The magnetorheological rotating load apparatus of claim 1, wherein a certain gap provided at least between the yoke and the rotating ring and filled with the magnetorheological fluid has a size 10 times to 200 times greater than an average diameter of magnetic particles in the magnetorheological fluid.

9. The magnetorheological rotating load apparatus of claim 1, wherein a certain gap provided at least between the yoke and the rotating ring and filled with the magnetorheological fluid has a size of at least 0.1 mm to 5 mm.

10. The magnetorheological rotating load apparatus of claim 1, further comprising a controller for controlling a magnetic field applied from the coil to the magnetorheological fluid.

11. The magnetorheological rotating load apparatus of claim 10, wherein the controller transmits a pattern signal to the coil based on event pattern data corresponding to an effect of an event received from outside, or audio pattern data corresponding to an audio signal received from outside.

12. The magnetorheological rotating load apparatus of claim 10, wherein the controller transmits a direct current (DC) offset signal to the coil based on offset data corresponding to an operating mode received from outside.

13. The magnetorheological rotating load apparatus of claim 10, wherein, when it is determined that the shaft has reached a specific rotation position, the controller transmits a position recognition signal to the coil.

14. The magnetorheological rotating load apparatus of claim 10, wherein, when it is determined that the shaft rotates in a reverse rotation direction opposite to a forward rotation direction, the controller transmits a rotation stop signal to the coil.

15. The magnetorheological rotating load apparatus of claim 10, wherein, when it is determined that the shaft rotates in a reverse rotation direction opposite to a forward rotation direction, the controller controls the coil to apply no magnetic field to the magnetorheological fluid.

16. The magnetorheological rotating load apparatus of claim 10, wherein the controller transmits a pre-input signal to the coil before the magnetorheological rotating load apparatus operates, and
wherein the pre-input signal is a signal for moving particles settled in the magnetorheological fluid to form an incomplete or complete chain shape in at least one of vertical and horizontal directions in a certain gap, and then redispersing the particles.

17. The magnetorheological rotating load apparatus of claim 16, wherein the incomplete chain shape is a spike shape.

18. The magnetorheological rotating load apparatus of claim 8, wherein, when a controller applies an operating voltage V₁ to the coil and when it is determined that a height of chains formed by the particles of the magnetorheological fluid in the certain gap between the yoke and the rotating ring is lower than a height of the gap, the controller applies a voltage V₂ higher than V₁.

19. The magnetorheological rotating load apparatus of claim 10, wherein, when an operating temperature of the magnetorheological rotating load apparatus is increased compared to an initial operating temperature, the controller maintains a torque strength of the initial operating temperature by controlling a strength or a pattern of the magnetic field.

20. The magnetorheological rotating load apparatus of claim 1, wherein at least one of a viscosity of the magnetorheological fluid, a content of magnetic particles in the magnetorheological fluid, numbers of yokes and rotating rings, areas of the yoke and the rotating ring, a size of a gap between the yoke and the rotating ring, and a strength of a current applied to the coil is set to prevent rotation manipulation of a user in a specific situation by increasing a maximum value of rotational torque applied between the yoke and the rotating ring.

21. The magnetorheological rotating load apparatus of claim 1, wherein at least one of the housing, the yoke, and the rotating ring comprises a portion made of a magnetic material.
